(19) United States
(12) Patent Application Publication
(10) Pub. No.: US 2024/0036962 A1
(43) Pub. Date: Feb. 1, 2024

(54) PRODUCT LIFECYCLE MANAGEMENT

(71) Applicant: DevRev, Inc., Palo Alto, CA (US)

(72) Inventors: Dominik Damjakob, Austin, TX (US); Shlomi Vaknin, San Jose, CA (US); Ashwini Vasanth, West Lafayette, IN (US); Steven Poitras, Austin, TX (US); Mohan Maturi, San Jose, CA (US); Nimar Arora, Union City, CA (US); Amit Gosavi, Pune (IN); Srividya Tata, Bangalore (IN)

(73) Assignee: DevRev, Inc., Palo Alto, CA (US)

(21) Appl. No.: 18/361,683

(22) Filed: Jul. 28, 2023

Related U.S. Application Data
(60) Provisional application No. 63/393,641, filed on Jul. 29, 2022.

(51) Int. Cl. G06F 11/07

(52) U.S. Cl. CPC G06F 11/0781; G06F 11/0793; G06F 11/079; G06F 11/076

(57) ABSTRACT

The present subject matter discloses techniques to automatically cluster events generated by a plurality of distinct ecosystems deployed in a connected environment in relation to a product. In operation, the clustered events may be correlated, and one or more of the correlated events that trigger a response may be identified as an actionable item. Based on a correlation between the actionable items, a hierarchical product parameter responsible for the actionable item may be identified. The hierarchical product parameter is an operational factor in a hierarchy of operational factors associated with the product, where the hierarchy of operational factors span over the plurality of distinct ecosystems operating in relation to the product. Subsequently, one or more entities across the distinct ecosystems may be notified of the actionable item, to initiate a required action. Further, techniques to detect operational factors associated with the product deployed in the distinct ecosystems are disclosed.

### CROSS-REFERENCE TO RELATED APPLICATIONS

The present application claims the benefit of priority to U.S. Provisional Application No. 63/393,641, which is hereby incorporated by reference in its entirety.

### BACKGROUND

Typically, products and services deployed in a computing environment touch upon, inhabit, or interrelate with numerous disparate locations, devices, and/or entities that pertain to the product or service. Each of these disparate locations, devices, and/or entities may inhabit a compartmentalized ecosystem that is distinct from—and effectively walled off from—any of the other compartmentalized ecosystems operating in the computing environment. For example, an organization that develops a software product may inhabit a development ecosystem having a set of development tools and databases that are organized and optimized for the software development process. A user(s) of the software product may correspond to a set of computing systems, machines, or server devices configured for the efficient execution of the developed software product. Further, an administrator of the software product may correspond to a set of computing systems configured with operational or monitoring tools that may be used to administer the software product. Additionally, a customer relationship personnel may correspond to a set of systems or tools to manage the interactions with the users (e.g., using CRM systems, billing systems, etc.) in relation to maintaining sales and/or customer relationships.

Similarly, an organization providing services instead of products may have certain equivalent configurations focused on enabling the delivery of the services as compared to a product. The configurations may correspond to a geographical location for service delivery, scope of services delivered, and the like. In certain cases, users of the service may be either internal to the organization or may be operating in an environment external to the organization.

### SUMMARY

Embodiments of the invention provide an approach to automatically cluster events generated by a plurality of distinct ecosystems deployed in a connected environment in relation to a product. In operation, the clustered events may be correlated, and one or more of the correlated events that trigger a response may be identified as an actionable item. Based on a correlation between the actionable items, a hierarchical product parameter responsible for the actionable item may be identified. The hierarchical product parameter is an operational factor in a hierarchy of operational factors associated with the product, where the hierarchy of operational factors span over the plurality of distinct ecosystems operating in relation to the product. Subsequently, one or more entities across the distinct ecosystems may be notified of the actionable item, to initiate a required action. Further, techniques to detect operational factors associated with the product deployed in the distinct ecosystems are disclosed.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are not therefore to be considered limiting of its scope, the present subject matter will be described and explained with additional specificity and detail through the use of the accompanying drawings.

FIG. 1 provides an illustration of a connected environment, in accordance with an example implementation of the present subject matter.

FIG. 2 illustrates a conceptual schematic of generation of an event correlation map, according to an example implementation.

FIG. 3A illustrates a method for identifying an actionable event for a product deployed in a connected environment, according to an example implementation.

FIG. 3B illustrates a method for identifying an operational factor for a product deployed in a plurality of distinct ecosystems, according to an example implementation.

FIG. 4 provides a connected environment comprising four distinct ecosystems related to a common product and/or service built and deployed by an organization, according to an example implementation.

FIG. 5 illustrates a hierarchy of operational factors and interrelationships between the operational factors, according to an example implementation.

FIG. 6 shows an illustration of a system architecture diagram according to some embodiments of the present subject matter.

FIG. 7 shows a flowchart of an approach to perform cross-ecosystem analysis according to some embodiments of the present subject matter.

FIG. 8 provides an illustration of a machine learning (ML) architecture according to an example implementation of the present subject matter.

FIG. 9 shows an illustration of logical relationships that may exist between the consumers and orgs for Developer and User.

FIG. 10 illustrates a conceptual schematic for identification of an operational factor for a product deployed in a connected environment having a plurality of ecosystems, according to an example implementation.

FIG. 11 illustrates a conceptual schematic for identification of a user-related operational factor for a product deployed in a connected environment having a plurality of ecosystems, according to an example implementation.

FIG. 12 illustrates a conceptual schematic for identification of a developer-related operational factor for a product deployed in a connected environment having a plurality of ecosystems, according to an example implementation.

FIG. 13 illustrates a conceptional schematic for linking developer-related operational factors and user-related operational factors.

FIG. 14 provides a schematic of the full operational factors identification and linking of the operational factors across ecosystems.

FIG. 15 illustrates a schematic overview of the event workflow during identification of operational factors through external version control systems.

FIG. 16 illustrates a conceptual schematic for ideation and prioritization of hierarchical product parameters in relation to the identified operational factors associated with one or more entities operating in a plurality of distinct ecosystems in a connected environment.

FIG. 17 illustrates a conceptual schematic for linking Devices to hierarchical product parameters and providing auto-assignment options.

FIG. 18 provides a conceptual schematic 1800 determining a link between developer-related hierarchical product parameters and impacted user-related hierarchical product parameters.

FIG. 19 illustrates a workflow 1900 for ideation of actionable items, based on hierarchical product parameters.

FIG. 20 provides a schematic illustration for prioritization of the actionable items.

FIG. 21 illustrates a conceptual schematic 2100 for individualization of hierarchical product parameters associated with a particular entity from amongst one or more entities operating in distinct ecosystems.

FIG. 22 illustrates a schematic view of insight generation on the trails user interface.

FIG. 23 illustrates a schematic view of a trails user interface according to an example implementation.

FIG. 24 is a block diagram of an illustrative computing system suitable for implementing an embodiment of the present invention.

### DETAILED DESCRIPTION

Certain organizations may develop and deploy products and/or services in a connected computing environment. The connected computing environment in relation to a particular product and/or service of the organization includes one or more distinct ecosystems inhabited by user-end entities and developer-end entities of the particular product and/or service of the organization. Each of the one or more distinct ecosystems, while operating, produces a stream of data pertaining to events that describe an activity or change in the ecosystems. The events may generally be unique to each distinct ecosystem but may reference some entities that span the distinct ecosystems. The product and/or service and one or more entities associated with the product and/or service are common across all ecosystems and the events reference the common components of the product and/or service either directly or indirectly. The terms products and services have been used interchangeably throughout the specification.

Since the distinct ecosystems are typically isolated from one another, it is normally not possible to adequately and effectively perform analysis to obtain meaningful data that spans across the boundaries of the distinct ecosystems. Moreover, the stream of data pertaining to events pertaining to events generated by the distinct ecosystems would likely correlate to an extremely high volume of data. Therefore, any organization that seeks to analyze data from across the distinct ecosystems would be inundated with a high volume of events coming from many diverse sources.

Conventional approaches taken by software or service organizations face immense struggles to effectively identify events, extract value from the events, and respond efficiently to the events. For example, one conventional approach is to use a manual process to analyze data streams pertaining to activities occurring at the distinct ecosystems, where a significantly high level of human effort is required to be devoted to individually identify and analyze the activities in order to identify events and act on them appropriately. The manual process is, however, both costly and reactive rather than proactive, and tends to suffer from the inability of humans to be able to accurately and efficiently process huge amounts of data. The analysis based on the conventional approach thus tends to be incomplete, inaccurate, or just plain wrong in many cases. For instance, events such as test failures, customer login problems, service timeouts in data centers, etc. can be captured from the distinct ecosystems and could have a common root cause, where the root cause would possibly remain undetected if the human-based manual analysis approach is taken to analyze the events. Additionally, identification of one or more entities at the distinct ecosystems that may require a modification related to the correction of the root cause is difficult.

The present subject matter discloses techniques to automatically cluster events generated by a plurality of distinct ecosystems and to correlate them to identify product parameters across the distinct ecosystems responsible for an event. The plurality of distinct ecosystems may exist in relation to a product deployed in a connected environment. The present subject matter functions in two stages: a setup stage and a runtime stage. At the setup stage, the events received from the distinct ecosystems may be correlated to obtain an event correlation map. The event correlation map may provide a coherent converged picture of a data stream pertaining to events captured from the various distinct ecosystems. The event correlation map may include events correlated to form incidents representing the event necessary for indication to a user-end entity and/or a developer-end entity operating in one or more distinct ecosystems. The incidents are automatically triaged to identify tickets and the severity of the tickets is ascertained from an object associated with the incidents. The tickets refer to one or more incidents that may require certain cosmetic modifications. Further, the tickets that may reference underlying defects with the product or service are converted into issues. The incidents, tickets, and issues, referred to collectively as items are provided onto the event correlation map. Each item of the event correlation map may be associated with a plurality of objects providing a description of the activities leading to the generation of the item.

At the runtime stage, one or more of the items which trigger a response may be identified as an actionable item. Based on a correlation between the actionable items, a hierarchical product parameter responsible for the actionable item may be identified. The hierarchical product parameter may be understood as a parameter associated with a specific level of granularity in a hierarchy of operational factors associated with the product. The operational factors associated with the product may span over the plurality of distinct ecosystems operating in relation to the product deployed in the connected environment. The operational factors may be divided amongst user-end entities and/or developer-end entities responsible for causing them or fixing them. A person authorized to undertake an action at one or more computing systems at the specific user-end and/or developer-end entities may be notified of the actionable item. Upon being notified, the person may initiate one or more responses required to address the actionable item. Therefore, the intensive task of identifying actionable items and appropriately addressing the actionable items is made simpler and more efficient. In addition, the actionable items are assigned a priority level for action at the specific user-end and/or developer-end entities to allow critical actionable items to be addressed on priority. The priority level may be determined by the scope and level of severity determined based on one or more objects associated with the actionable items, explained in detail with respect to figures.

In another exemplary implementation, the present subject matter provides techniques to detect and interact with entities inside an organization. At the setup stage, one or more entities deployed in a connected environment with respect to a product of the organization may be auto-detected. The entities may be at least one of the user-end entities and developer-end entities in relation to one or more distinct ecosystems inhabited by such entities. Further, operational factors associated with the product deployed in the distinct ecosystems may be automatically detected by extracting information related to how the operations of the entities are executed and synthesizing the extracted information. A hierarchy of the operational factors may be obtained and one or more hierarchical product parameters in relation to the operational factors may be obtained for each specific ecosystem.

At the runtime stage, the present subject matter provides techniques to obtain visualization of the hierarchy of operational factors and hierarchical product parameters. Further, each hierarchical product parameter may be ranked for prioritization by the specific user-end and/or developer-end entities authorized for undertaking an actional in relation to the each hierarchical product parameter. While certain embodiments described below may pertain to products or services specifically directed to software, the present subject matter is not limited in its applicability to just software and is indeed applicable to any type of product or service.

The present subject matter addresses a significant problem of product lifecycle management, which is that the developer-end entities and user-end entities remain greatly disconnected from the operations conducted within the distinct ecosystems they inhabit. By removing barriers between the developer-end entities and user-end entities, code on the developer-end may be connected to the operations at the user-end. Consequently, in an example implementation, the developer-end entities may efficiently address production issues and user interactions on the user-end entities. Therefore, the entities are no longer required to work across silos of data generated by distinct ecosystems to meaningfully communicate and collaborate among each other in the connected environment. Accordingly, the inefficiencies in the product lifecycle management may be addressed.

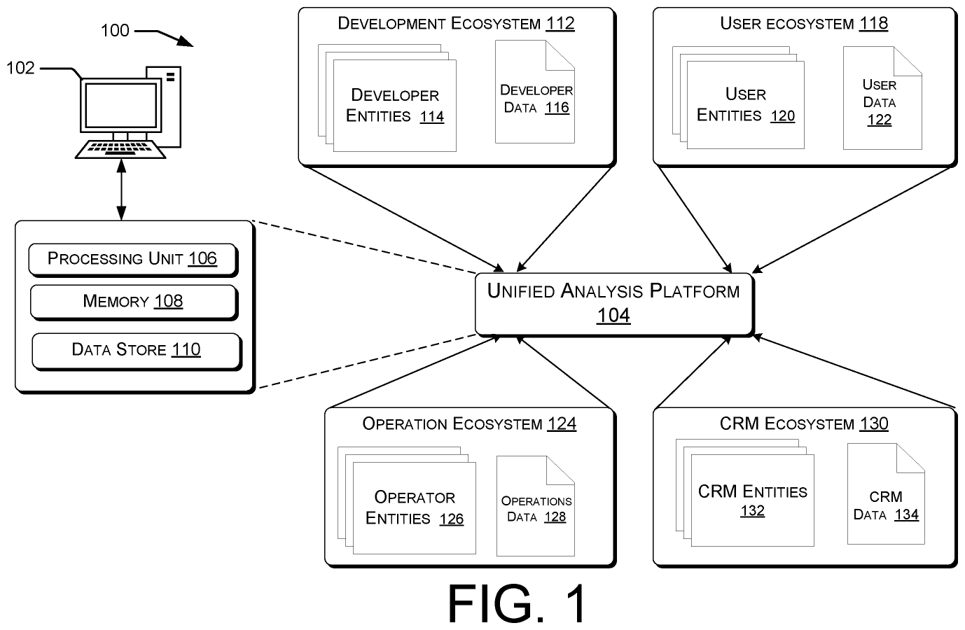

The present subject matter is further described with reference to FIGS. 1-24. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 provides an illustration of a connected environment 100, in accordance with an example implementation of the present subject matter. The connected environment 100 may include multiple entities operating in relation to a product. In an example, the multiple entities operating in the connected environment 100 may inhabit distinct ecosystems pertaining to the functionality being executed on each entity in the connected environment 100. The connected environment 100 may be controlled by a system (not shown). The system may include a user station 102 to operate a unified analysis platform 104. The user station 102 that hosts the unified analysis platform 104 includes any type of computing device that may be used to implement, operate, or interface with the unified analysis platform 104. The computing device may include, for example, workstations, personal computers, mobile devices, servers, hosts, nodes, or remote computing terminals. The user station 102 comprises a display device, such as a display monitor, for displaying an interface to users at the user station. The user station 102 also includes one or more input devices (not shown) for a user to achieve operational control over the activities of the connected environment 100. The input devices may include a mouse and/or keyboard to manipulate a pointing object in a graphical user interface to generate user inputs.

The user station 102 may be communicably coupled to a processing unit 106, a memory 108, and a data store 110. The processing unit 106 enables the user station 102 to run at least one operating system and other applications and services. The processing unit 106, amongst other capabilities, may be configured to fetch and execute computer-readable instructions stored in the memory 108. The processing unit 106 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine-readable instructions.

The functions, performed by the processing unit 106, may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the user station 102 to interact with different components. Further, the interface may enable the user station 102 to communicate with entities, for example, the entities operating in the various distinct ecosystems, web servers, and external repositories. The interface may facilitate multiple communications within a wide variety of networks and protocol types, including wireless networks, wireless Local Area Network (WLAN), Radio Access Network (RAN), satellite-based network, and the like.

The memory 108 may be coupled to the processing unit 106 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The operation of the unified analysis platform 104 involves analysis of large amounts of data streams captured from the distinct ecosystems to identify events occurring at the distinct ecosystems for processing by the unified analysis platform 104. The unified analysis platform 104 implements autonomous clustering of the events to generate items of interest to one or more entities operating in distinct ecosystems. The items of interest may be an event necessary for notification to the one or more operating in a plurality of distinct ecosystems as well as autonomous classification and communication between these items.

Any number or type of events generated by distinct ecosystems may be acted upon by embodiments of the invention. For example, the connected environment 100 includes a development ecosystem 112 having developer entities 114 and generating developer data 116, a user ecosystem 118 comprising user entities 120 and generating user data 122, an operation ecosystem 124 comprising operator entities 126 and generating operations data 128, a Customer Relationship Management (CRM) ecosystem 130 comprising CRM/Revenue-based entities 132, and generating CRM data 134. For the sake of understanding, the development ecosystem 112 and operation ecosystem 124 may be collectively referred to as developer-end ecosystems, and the user ecosystem 118 and CRM ecosystem 130 may be collectively referred to as user-end ecosystems.

In some embodiments, the unified analysis platform 104 uses machine-learning based techniques to automatically process the data and events generated by the distinct ecosystems to generate an event correlation map. In an example, the event correlation map may be generated by clustering and correlating the data generated by each distinct ecosystem in the connected environment 100. The unified analysis platform 104 stores both raw data generated by each distinct ecosystem and the event correlation map illustrating properly categorized data at the data store 110, so that the processing unit 106 can be used to accurately identify actionable items. The actionable items may be one or more items of interest on the event correlation map that may require a response trigger. In this way, a correlated view of the data pertaining to distinct ecosystems can be obtained, despite the fact that the data may be originated from numerous entities operating in the distinct ecosystems, and despite the fact that the collected data may correspond to an immense amount of data that may be captured.

The disclosed techniques, therefore, allow organizations to focus their efforts on the actionable items in their product and anticipate and trigger a required response for the actionable items before the actionable item may be reported. The present subject matter may be applicable to any organization that develops products that are delivered to end users in a manner that events captured during the development, deployment, and usage of the product may aid in monitoring the health of the product. The present subject matter outlines an application of the inventive method for the Software-as-a-Service (SaaS) industry, but it is not limited to this industry.

Embodiments of the present subject matter operate by capturing data streams from the distinct ecosystems within the connected environment 100 through a series of triaging stages. Objects associated with the captured data streams may be “funneled” through the series of triaging stages to generate the event correlation map containing meaningful sets of analyzed data. The raw data generated by the distinct ecosystems are likely to correspond to an extremely large volume of data, which individually by themselves may not provide enough cross-hierarchy context to be meaningful. The large volume of raw data, when analyzed in a unified way across the distinct ecosystems, may be triaged into increasingly smaller and more meaningful sets of data that can be usefully provided to developers, users, managers, and/or any other party that can benefit from a unified cross-hierarchy look at events and data within the connected environment 100.

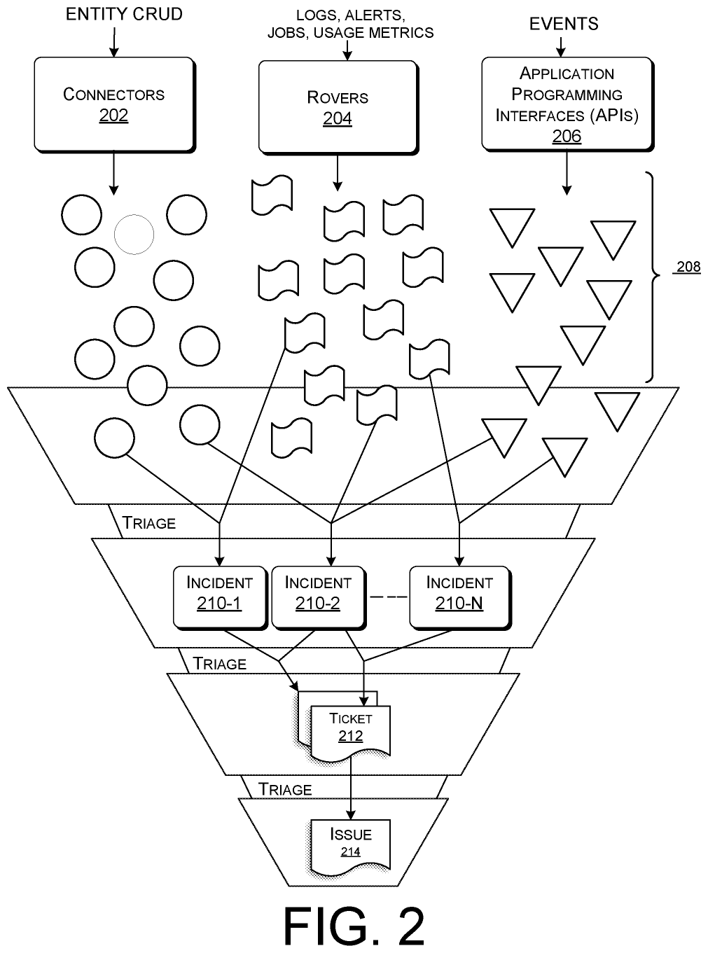

FIG. 2 illustrates a conceptual schematic for generation of an event correlation map. In an example implementation, the illustrated conceptual schematic 200 may be implemented by a unified analysis platform, such as the unified analysis platform 104 discussed in relation to FIG. 1. The unified analysis platform may include one or more data capturing tools implemented to capture items from one or more entities operating in distinct ecosystems using any suitable mechanism or technique. For example, the data capturing tools may include connectors 202, rover(s) 204, and/or Application Programming Interfaces (APIs) 206.

In an example, the connectors 202 may provide bi-directional communications between the unified analysis platform and one or more entities operating in the distinct ecosystems. For example, the connectors 202 may be used with respect to entity CRUD (“create, read, update, delete”) operations. The rover(s) 204 may be used to implement pure collection activities in a single direction from the entities operating in the distinct ecosystems. For example, the rover(s) 204 may collect logs, alerts, jobs, and usage data from the entities operating in the distinct ecosystems. The APIs 206 may be used to implement programmatic access to the entities operating in the distinct ecosystems and pull data from the entities operating in the distinct ecosystems, for example, from developer-end entities.

The items collected by the data capturing tools may pertain to one or more events 208 indicative of an activity at the entities operating in the distinct ecosystems. The events 208 may be triaged in different levels to generate one or more items of interest. In an example, each level includes a triaging logic to generate increasingly meaningful and smaller sets of items, referred to as items of interest.

The events 208 may progress through a series of triaging logics applied to cluster and classify the events 208 into the one or more items of interest. The series of triaging logics may be implemented using machine-learning based techniques. For example, at a first level, events of interest (e.g., which are correlated across multiple distinct ecosystems) may be clustered into event clusters. Further, the event clusters may be classified to generate one or more incidents, such as incident 210-1, 210-2 . . . 210-N, collectively referred to as incidents 210. Incidents 210 may correspond to one or more events from the event clusters occurrence of which may be important for notification to the one or more entities operating in the distinct ecosystems. In a subsequent level, incidents that require human or machine interactions may be clustered into incident clusters, using the triaging logic. Further, the incident clusters may be classified to generate a ticket 212. The ticket 212 may be associated with a severity level indicative of how urgently an action on the ticket 212 may be required. Ticket 212 with a severity level beyond a threshold level may be acted upon by another triaging logic to create an issue 214. For example, an issue 214 may be created if a production and/or service change is deemed extremely necessary based upon the severity level of the ticket 212. One or more of the incidents, tickets, and issues that require a response trigger may qualify as an actionable item. In an example, the response trigger may include requirement of a notification to one or more authorized entities operating in the distinct ecosystems related with the actionable item.

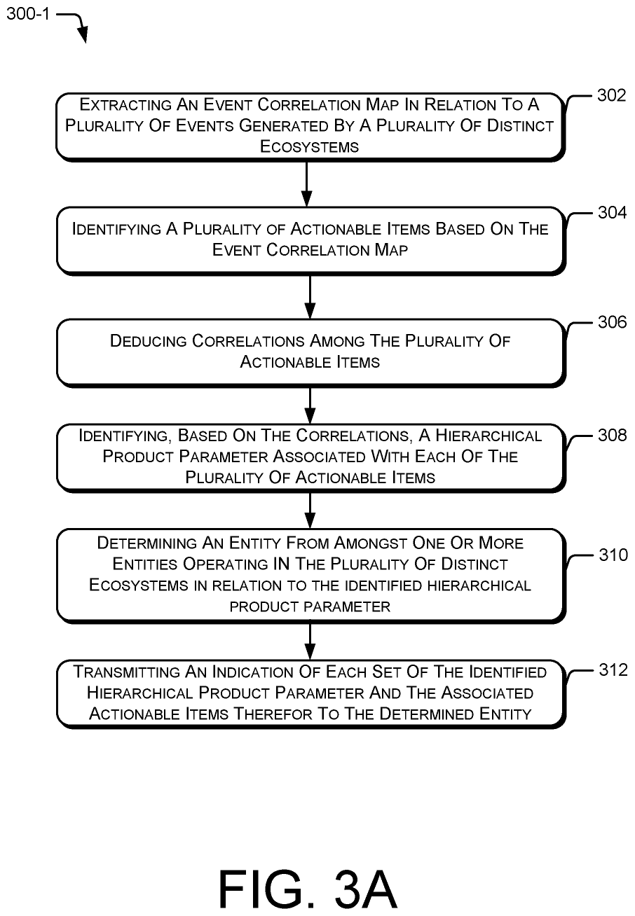

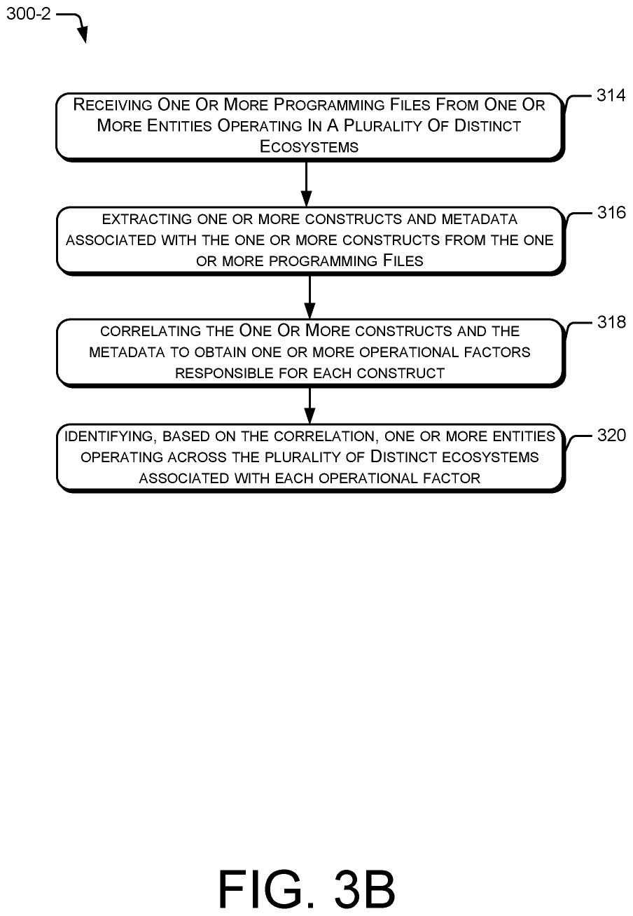

FIG. 3A illustrates a method 300-1 for identifying an actionable event for a product deployed in a connected environment having a plurality of distinct ecosystems, according to an example implementation of the present subject matter. The order in which the method 300-1 is described is not intended to be construed as a limitation, and any number of the described method blocks may be combined in any order to implement the method 300-1, or an alternative method. Furthermore, the method 300-1 may be implemented by processor(s) or computing device(s) through any suitable hardware, non-transitory machine-readable instructions, or a combination thereof.

It may be understood that steps of the method 300-1 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. The method 300-1 may be performed by a unified analysis platform 104 in communication with the processing unit 106, memory 108, and data store 110 communicably coupled with a user station 102.

At step 302, an event correlation map is extracted in relation to a plurality of events generated by a plurality of distinct ecosystems. In an example, an event is indicative of occurrence of an activity at one or more entities operating in the plurality of distinct ecosystems.

At step 304, a plurality of actionable items based on the event correlation map is identified. In an example, an actionable item is a response trigger associated with the one or more events from amongst the plurality of events.

At step 306, correlations among the plurality of actionable items are deduced.

At step 308, a hierarchical product parameter associated with each of the plurality of actionable items is identified based on the correlations. In an example, the hierarchical product parameter is an operational factor associated with the product within a hierarchy of operational factors.

At step 310, an entity from amongst the one or more entities operating in the plurality of distinct ecosystems in relation to the identified hierarchical product parameter is determined. In an example, the determined entity is authorized to undertake an action in relation to the identified hierarchical product parameter associated with each of the plurality of actionable items.

At step 312, an indication of each set of the identified hierarchical product parameter and the associated actionable items therefor is transmitted to the determined entity.

FIG. 3B illustrates a method 300-2 for identifying an operational factor for a product deployed in a plurality of distinct ecosystems, according to an example implementation of the present subject matter. The order in which the method 300-2 is described is not intended to be construed as a limitation, and any number of the described method blocks may be combined in any order to implement the method 300-2, or an alternative method. Furthermore, the method 300-2 may be implemented by processor(s) or computing device(s) through any suitable hardware, non-transitory machine-readable instructions, or a combination thereof.

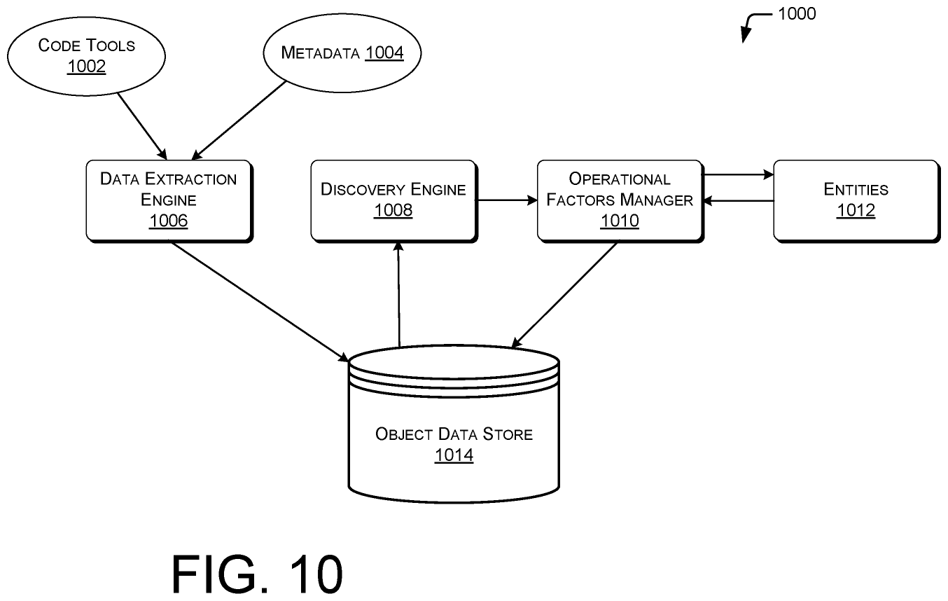

It may be understood that steps of the method 300-2 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. The method 300-2 may be performed by components of the conceptual schematic described in relation to FIG. 10.

At step 314, one or more programming files are received from one or more entities operating in a plurality of distinct ecosystems.

At step 316, one or more constructs and metadata associated with the one or more constructs are extracted from the one or more programming files.

At step 318, the one or more constructs and the metadata are correlated to obtain one or more operational factors associated responsible for each construct.

At step 320, one or more entities operating across the plurality of distinct ecosystems associated with each operational factor are identified. In an example, the one or more entities may be identified based on the correlation between the one or more constructs and the metadata.

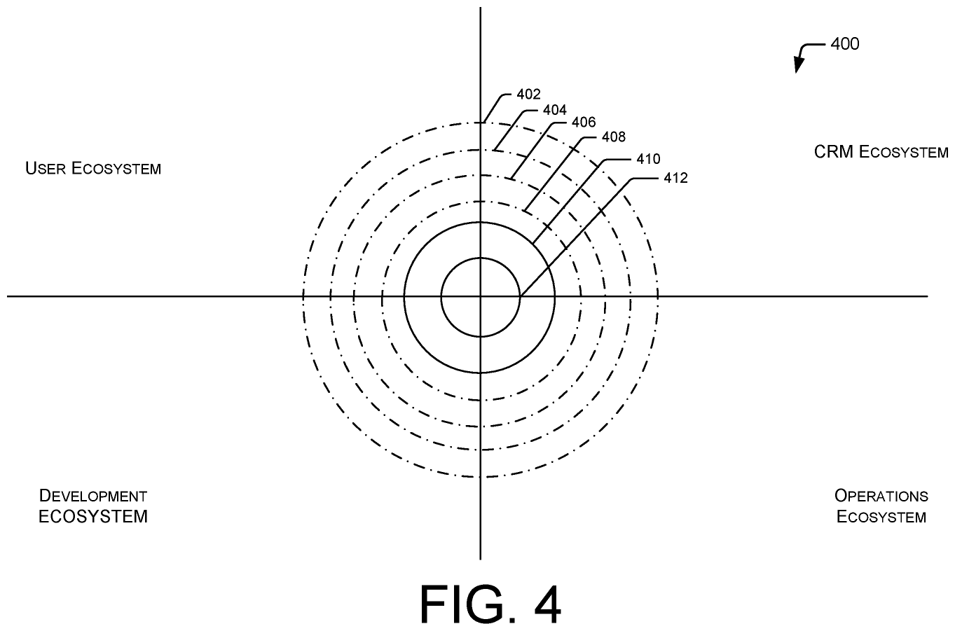

As is evident, central to various embodiments of the present subject matter are the products operating in distinct ecosystems and events generated at each distinct ecosystem. FIG. 4 provides a connected environment 400 comprising four distinct ecosystems related to a common product and/or service built and deployed by an organization. While four specific ecosystems are shown in the current embodiment figures, it is noted that other and additional ecosystems may be implemented for additional embodiments. Therefore, the scope of the invention is not to be limited just to the specific ecosystems illustrated in the figures but may encompass other ecosystems as well.

For the sake of explanation, FIG. 4 is divided into four quadrants, where each quadrant represents a different ecosystem. The lowest two quadrants correspond to developer-end ecosystems. The lower left quadrant represents a development ecosystem. The development ecosystem inhabits entities used by and interfaced with activities that are used to “build” a software product. The lower right quadrant represents an operations ecosystem. The operations ecosystem inhabits entities used by and interfaced with activities that are used to enable “operation” of the product. The upper two quadrants correspond to user-end ecosystems. The upper right quadrant represents a CRM ecosystem. The CRM ecosystem inhabits entities responsible for providing “support” to the operation of the software product. The upper left quadrant represents the user/customer ecosystem, which inhabits entities responsible for actual working on the software product.

The four quadrants are illustrated to include a set of concentric rings (depicted with dotted lines) which represent stages for triaging for events generated by the discrete ecosystems. A first ring 402 encompasses the greatest area of the connected environment 400, and represents event data generated by the discrete ecosystems. From the first ring 402, the events may be triaged using a triaging logic to form a second ring 404 representing incidents, which correspond to the next stage from events. A third ring 406 corresponds to the tickets, which is the next stage from the incidents. A fourth ring 408 corresponds to the issues, which is the next stage from the tickets. FIG. 4 shows even more rings (shown with solid lines) within these above-described rings, which relate to granular aspects of the products created by the developers. These granular aspects of the product may be referred to as operational factors for the product. The solid concentric rings, as depicted, may represent a hierarchy of operational factors. For example, FIG. 4 shows a first solid ring 410 corresponding to the granularity of a “component” and/or “feature”. Within the first solid ring 410, the next level of granularity is a second solid ring 412 at the granularity of a “service”, “microservice”, and/or “capability”.

As previously noted, the lower left quadrant represents the development ecosystem. The development ecosystem inhabits entities used by and interfaced with software development activities that are used to “build” a software product. Each level in an event correlation map (depicted by dotted concentric rings) may involve an entity responsible for the generation of the event and an object descriptive of the activity performed by the entity leading to the event. At an event level, a non-exclusive list of entities generating the event, referred to as event entity, may include service registry tools, security compliance analysis, continuous deployment tools, continuous integration tools, and/or version control systems. Examples of such entities that produce event data for the development ecosystem may include, GitHub, Gitlab, Git, CircleCL, Jenkins, Artifactory, and/or service registries (e.g., with regards to Kubernetes, consul, DNS, etc.). At an incident level, entities, referred to as incident entity, in the development ecosystem may include entities associated with, for example, integration engineers, project maintainers, and/or build engineers. Examples of incident objects are merge requests, fork/branch, pipeline/workflow milestones, job/stage completions, package creation, and/or artifact promotion/distribution. At a ticket level, entities, referred to as ticket entity, in the development ecosystem may be associated with, for example, test engineers. Examples of ticket objects are test failures, repo cloning, repo branching, pipeline updates, workflow tuning, job anomalies, security scan failures, artifact promotion, and/or canary rollout failures. At an issue level, entities, referred to as issue entity, in the development ecosystem may be associated with, for example, the actual developers themselves. Examples of issue objects are product bugs and/or unit test bugs. At a component level, a unified analysis platform, such as the unified analysis platform 104, may autonomously learn about components based at least in part upon, for example, directory structures for the code and/or unit test directory location. At a service/microservice level, the unified analysis platform 104 may autonomously learn about services based at least in part on, for example, service registries and/or load balancer proxies.

During an analysis stage, clustering and/or classification and/or communications operations may be performed upon the events for the development ecosystem. With regards to clustering, one or more of the following may be performed: (a) deduplication of incidents, (failed) workflows, and/or jobs; (b) correlation between upstream changes (e.g., in Git) and downstream failures (e.g., CI/CD failures); (c) anomaly detection; and/or (d) correlating code and test suites with components and (micro)services. With regards to classification, one or more of the following may be performed: (a) attribution; (b) prioritization; and/or (c) recommendation (e.g., garbage collection tickets and issues, promote tags to fields and demote fields to tags, hush noisy incidents, and detect alert spam). With regards to communications, one or more of the following may be performed: (a) context sensitive collaboration; (b) real time notification; and/or (c) cross-funnel propagation.

The lower right quadrant represents the operations ecosystem. The operations ecosystem inhabits entities used by and interfaced with activities that are used to enable “operation” of the product. At the event level, a non-exclusive list of entities, referred to as event entity, generating the event data for the operations ecosystem may include image repositories, cloud monitoring tools, service mesh, service registry tools, observability tools, and/or infrastructures (e.g., Kubernetes). Examples of event entities for the operations ecosystem may include public cloud outages, network provider outages, service registries, and/or logs and log analytics. With respect to the operations ecosystem, the incident entity may include, for example, network security engineers, cloud operations engineers, and/or site reliability engineers. Examples of incident objects are artifact promotion, service uptime/performance, mesh upgrade failures, network breaches, A/B testing data, canary/staged rollout data, DDoS attack information, and/or observability anomalies. A ticket entity may be entities associated with, for example, DevOps engineers. Examples of ticket objects are artifact promotion/deployment failures, ingress/regress CRUD, mesh upgrade failures, canary rollout failures, and/or A/B testing tasks. An issue entity may include entities associated with, for example, the actual developers themselves. Examples of issue objects are product scale and performance bugs, upgrade bugs, feature rollout bugs, security holes, service-to-service compatibility bugs, and/or API gateway bugs. At the component level, the unified analysis platform 104 may autonomously learn about, for example, correlations between user features and source code components/teams for clustering and classification of issues. At the service/microservice level, the unified analysis platform 104 may autonomously learn about, for example, correlations between customer features and service/teams for classification of tickets and issues.

During an analysis stage, clustering and/or classification and/or communications operations may be performed upon the events for the operations ecosystem. With regards to clustering, one or more of the following may be performed: (a) deduplication of incidents, DDoS events, observability tool alerts, and/or service restarts (b) correlation between upstream artifact promotions and downstream service failures (c) anomaly detection; and/or (d) correlating code and test suites with components and (micro)services. With regards to classification, one or more of the following may be performed: (a) attribution; (b) prioritization; and/or (c) recommendation (e.g., garbage collection tickets and issues, promote tags to fields and demote fields to tags, hush noisy incidents, and detect alert spam). With regards to communications, one or more of the following may be performed: (a) context sensitive collaboration; (b) real time notification; and/or (c) cross-funnel propagation.

The upper right quadrant represents the CRM ecosystem. The CRM ecosystem inhabits entities responsible for providing “support” to the operation of the product. At the event level, a non-exclusive list of entities, referred to as event entity, generating the event data for the CRM ecosystem may include content delivery networks, social media, application stores, mobile applications, and/or a client browser. Examples of the event entities for the CRM ecosystem may include browsers (such as Chrome, Safari, Firefox), app stores (such as Apple App Store, Google Play), social media (such as Facebook, Instagram, Reddit, Twitter), and/or content delivery networks (such as Akamai, CloudFlare, CloudFront). An incident entity may be associated with, for example, Li support engineers and/or a marketing analyst. Examples of incident objects pertain to client app/browser crash, app downloads, feature tracking, social comments, and/or chatbot requests. A ticket entity may be associated with, for example, L3 support engineers, sales engineers, and/or product manager. Examples of ticket objects pertain to a request for enhancement, a new feature request, regression in behavior/usability/performance/reliability, entitlement (e.g., licensing), API throttle, and/or user provisioning. An issues may be associated with, for example, the actual developers themselves. Examples of issue objects pertain to a request for enhancement, and/or regression in behavior/usability/performance/reliability. At the features level, the unified analysis platform 104 may autonomously learn about, for example, correlations between product features and code components for the classification of tickets and issues. At the capabilities level, the unified analysis platform 104 may autonomously learn about, for example, correlations between product capabilities and running services for the classification of tickets and issues.

During the analysis stage, clustering and/or classification and/or communications operations may be performed upon the events generated by the CRM ecosystem. With regards to clustering, one or more of the following may be performed: (a) deduplication of incidents, clickstreams, social media alerts, cascading failures, cloud outages, and/or feature request tickets (e.g., RFEs) (b) correlation between upstream artifact promotions and downstream customer tickets, cloud and network outages, and/or new feature rollouts; (c) anomaly detection; and/or (d) correlating code and test suites with features and capabilities. With regards to classification, one or more of the following may be performed: (a) attribution; (b) prioritization; and/or (c) recommendation (e.g., garbage collect tickets and issues, promote tags to fields and demote fields to tags, hush noisy incidents, and detect alert spam). With regards to communications, one or more of the following may be performed: (a) context sensitive collaboration; (b) real time notification; and/or (c) cross-funnel propagation.

The upper left quadrant represents the user/customer ecosystem, which inhabits entities responsible for actual working on the software product. At the event level, a non-exclusive list of entities, referred to as event entity, generating event objects for the user/customer ecosystem may include an organic clickstream, a billing system, payment gateways, website analytic tools, and/or CRM systems. An incident entity generating incident objects may be associated with, for example, finance managers, account managers, and/or product managers. Examples of incident objects pertain to shopping carts, paywalls, data for shipping/registration/payment/billing/invoicing, onboarding, retention, upgrades, purchase orders, upsell/cross-sell data, and/or customer references. A ticket entity generating ticket objects may be associated with, for example, finance managers, account managers, and/or product managers. Examples of the ticket objects pertain to data for churn/attribution/cancellation, credit card bounce, feature/API rollout, and/or catalog updates. An issue entity generating issue objects may include, for example, revenue recognition bugs, design enhancements, and/or usage of third-party APIs. At the features level, the unified analysis platform 104 may autonomously learn about, for example, correlations between product features and code components for the classification of tickets and issues. At the capabilities level, the unified analysis platform 104 may autonomously learn about, for example, correlations between product capabilities and running services for the classification of tickets and issues.

During the analysis stage, clustering and/or classification and/or communications operations may be performed upon the event data for the user/customer ecosystem. With regards to clustering, one or more of the following may be performed: (a) deduplication of incidents, clickstreams, provisioning events, cascading failures, collection days, and/or large customer onboarding; (b) correlation between upstream feature/catalog/partner/API rollout and downstream customer tickets; (c) anomaly detection; and/or (d) correlating code and test suites with features and capabilities. With regards to classification, one or more of the following may be performed: (a) attribution; (b) prioritization; and/or (c) recommendation (e.g., garbage collection tickets and issues, promote tags to fields and demote fields to tags, hush noisy incidents, and detect alert spam). With regards to communications, one or more of the following may be performed: (a) context sensitive collaboration; (b) real time notification; and/or (c) cross-funnel propagation.

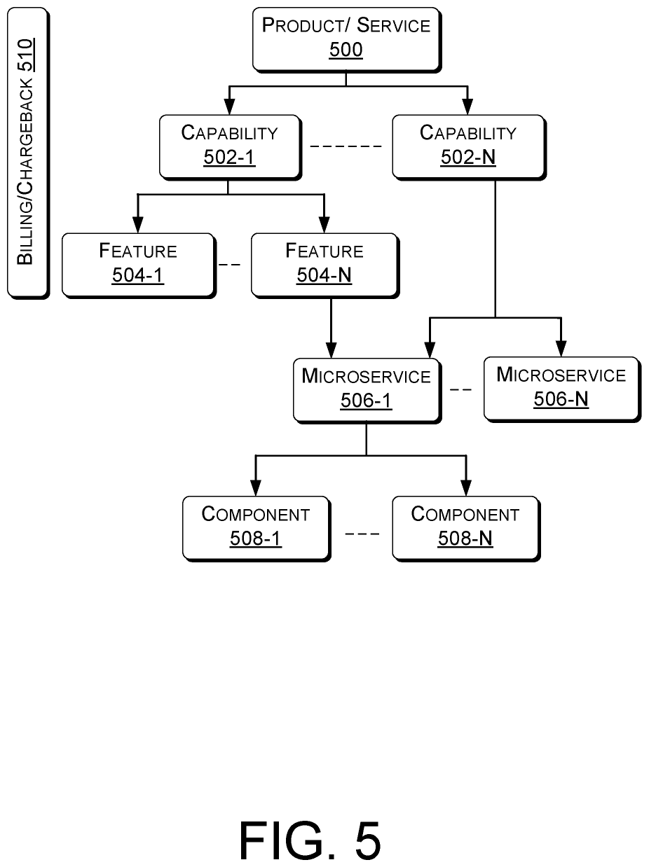

FIG. 5 illustrates a hierarchy of operational factors and interrelationships between the operational factors. The definition and standardization of the hierarchy of operational factors allows all events, actionable items, and activities to be consistent, coordinated and visible across all of the distinct ecosystems.

The product or service 500 is the origin entity that the hierarchy of operational factors is based upon. The product or service 500 is defined as a unit of profit and loss, identity, onboarding and contracting, collectively referred to as billing/chargeback 510. The product or service 500 can have one or more capabilities 502-1, 502-N, collectively referred to as capabilities 502, which is the core unit a user-end entity interacts with. The product or service 500 may have an Application Programming Interface (API) namespace in case delivered as a software product or service and can have associated service level agreements (SLA). A simple way to think about a capability 502 is that the capability 502 may provide entities (noun) and associated activities (verbs) that can be performed on the entities being provided. Each capability 502 can have configurable items that may be instantiated as one or more features 504-1, 504-N, collectively referred to as features 504. A feature 504 is specific to a capability 502 and is not commonly directly interacted with by the user-end entity. Using the noun/verb reference, as taken above, a feature may define/provide traits (adjectives) specific activities at an entity.

The capabilities 502 and/or features 504 may link to backend constructs, termed microservices 506-1, 506-N, collectively referred to as microservices 506, and components 508-1, 508-N, collectively referred to as components 508, most commonly, if the product/service 500 is a software product or service. A microservice 506 is a unit of deployment and may be an operational factor which composes a feature 504 or capability 502. In an example a feature 504-N may be composed by microservice 506-1. In another example implementation, a capability 502-N may be composed by a combination of microservices 506-1 and 506-N. At a further level in the hierarchy of operational factors is a component 508. The component 508 may be meant to be part of the entity, but not the entity as a whole.

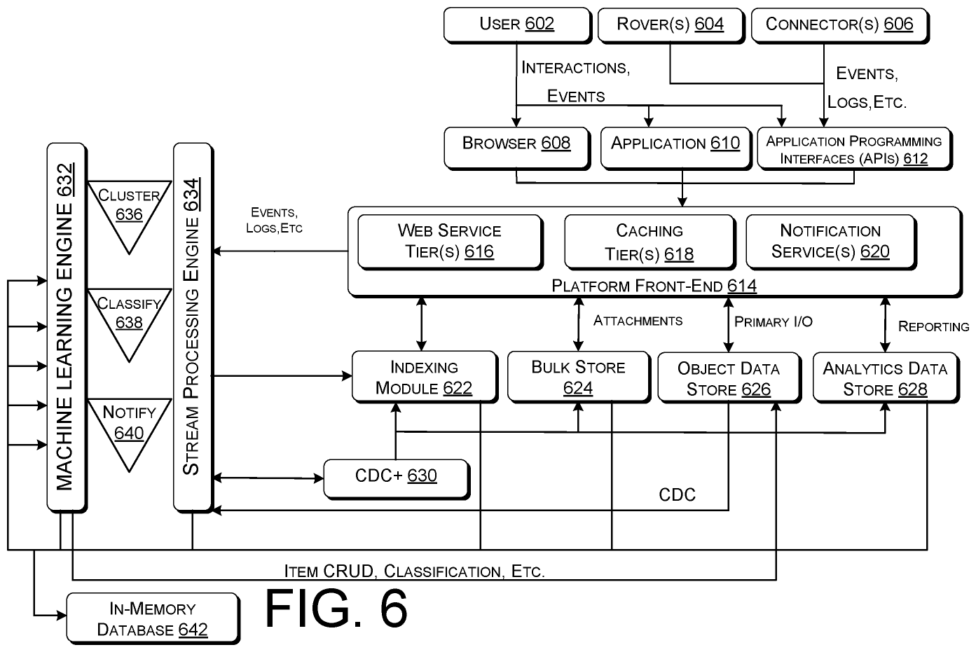

FIG. 6 shows an illustration of a system architecture diagram according to some embodiments of the present subject matter, where a machine learning (ML) architecture is provided to implement a unified analysis platform according to some embodiments of the present subject matter. One or more ML models in the ML architecture are implemented as part of ML components in the system architecture, with the streams pertaining to distinct ecosystems operating in relation to a product being processed as part of the ML architecture part of the streams processing in the system architecture.

In an example, data pertaining to activities undertaken at one or more entities operating in the distinct ecosystems in a connected environment may be collected. The data may be obtained from a user 602 operating in relation to a user-end entity through a browser 608. The user 602 may also be providing information through an application 610 being executed at the user-end entity. The user 602 may also interact with the unified analysis platform through Application Programming Interfaces (APIs) 612. Above-mentioned are exemplary conduits through which the user 602 may interact with the unified analysis platform, for example to provide information and/or to operate the unified analysis platform. Further, the user 602 may interact with the unified analysis platform to, for example, query the unified analysis platform, obtain notification communication, perform analytics, etc. In some embodiments, the browser 608 and application 610 may also communicate to the unified analysis platform using the APIs 612. For example, the application 610 may include hooks to publish events into the unified analysis platform, e.g., using the APIs 612.

Further, data generated by one or more entities operating in the connected environment is captured into the unified analysis platform using any suitable data capturing tools. In one example implementation, rover(s) 604 and connector(s) 606 may be implemented to capture data from entities operating in the connected environment. For example, connector(s) 606 may be used to collect data regarding development activities, events, and entity data from a development ecosystem. In addition, rover(s) 604 may be implemented on user ecosystem to gather real-time events that occur based upon user activities. As such, one or more databases that may be populated by the connector(s) 606 are part of a bulk store 624 in the system architecture. The events, incidents, tickets, and issues are stored as part of the object data store 626 in the system.

The rover(s) 604 may be implemented for each possible entity operating in the distinct ecosystems. The rover(s) 604 may collect events from the one or more entities into a centralized database (not shown) either by pulling through API calls from the unified analysis platform or by pushing from the one or more entities by adding a few lines of code that sends the data directly to the centralized database.

In parallel to rover(s) 604 and to supplement the data in events, connectors 606 pull in information about various systems of records that are used by the entities operating at each distinct ecosystem. The system of records are de-duplicated in an entity database (not shown) of the system architecture. The entity database also records the relationships between these entities.

In some embodiments, the rover(s) 604 may operate with a “pull” approach, which provides a one-way path to obtain information into the unified analysis platform and operates as a data-feed into the platform. This approach to obtaining information works very well with entities from which data just need to be consumed without necessarily needing synchronization in the other direction, such as a log file or message store. In contrast, the connector(s) 606, is bi-directional which synchronizes data between entities in the distinct ecosystems at the unified analysis platform, and which permits information to be published in both directions. The connector(s) 606 therefore requires a greater level of access, which may necessitate the establishment of privileges, creation of an ongoing session, and/or permission to create or update entities. To illustrate the different scenarios in which the rover(s) 604 may be used instead of the connector(s) 606, or vice versa, consider a software development organization that may use a software source control system to manage its coding projects. If there is a desire to merely publish events to the unified analysis platform, then a one-way pull component such as the rover 604 may be used to capture information from that source code control system. On the other hand, the user 602 may desire the ability to have the unified analysis platform be able to open, update or close actionable items that are created in the source control system, based upon analysis that occurred using the unified analysis platform. In such case, the connector 606 may implement the two-way communications that may allow the actionable items that may be stored in the object data store to be created, updated, or closed.

The system architecture includes a platform front-end 614 enabling the entities operating in the distinct ecosystems to interface with the unified analysis platform. The platform front-end 614 handles requests and information from external locations, and sends responses back to the external locations. The platform front-end 614 captures event information from the rover(s) 604, connectors 606, and users 602, and directs the captured information to the appropriate processing and/or storage location within the unified analysis platform 104. In an example implementation, the processing locations may be one of machine learning engine 632 and stream processing engine 634. Further, in the example implementation, the storage locations may be one of the bulk store 624, object data store 626, and analytics data store 628.

In the platform front-end 614, caching tier(s) 618 may include one or more cache components (e.g., memory, SSDs) to cache data received from the entities operating in the distinct ecosystems in an in-bound direction and/or communications intended to be sent to the entities operating in the distinct ecosystems in an out-bound direction. The caching tier 618 is useful, for instance, to efficiently interact with data without necessarily going back to the entity which was the source of that data, for each subsequent interaction of the unified analysis platform with the data. By way of example, in case there is an actionable item in the object data store 626, a notification of which may be required to be sent to the entities operating in the distinct ecosystems. Rather than constantly accessing that actionable item from the object data store 626, the information can be instead cached in the caching tier 618.

The notification services 620 provide notification to the entities operating in the distinct ecosystems, e.g., using the operation of the connector 606 to update the entities operating in the distinct ecosystems, direct information to the browser 608 or application 610 for the user 602, or provide a push notification, for example, notifications about updates to actionable items. The notification may not only be to developer-end entities (e.g., engineers or support personnel for a software development company), but may also be made to the user-end entities (the end-user of the product created by the software developer that is the user of the unified analysis platform).

One or more web service tier(s) 616 may be employed to act as API gateways to handle API requests and to handle both content subject matter and routing functionality. For example, with regards to context, the web service tier(s) 616 will add context to requests with augmentation, e.g., by pulling the appropriate JavaScripts or HTML pertinent to a given request. With regards to routing, the web service tier(s) 616 may send captured data to the appropriate processing and storage locations of the system architecture. For instance, events and logs are sent to the stream processing engine 634, large data items such as attachments are sent to/from the bulk store 624, reporting items are sent to/from the analytics data store 628, primary I/O items are sent to/from object data store, and search/indexing information are sent to/from an indexing module 622.

The machine learning engine 632 refers to a collection of machine learning modules that are listening to various events generated by the entities operating in the distinct ecosystems and interacting with the object data store 626. The machine learning modules maintain their transient state using an in-memory database 642, referred to as In-mem database 642.

Overall, the machine learning engine 632 is responsible for three primary tasks, namely clustering 636, classification 638, and notification 640. Clustering 636 refers to the aggregation of multiple similar events or objects to a single meta-event or meta-object that captures some underlying commonality among these events or objects. Classification 638 refers to the assignment of an attribute of an event based on analysis of past assignments by the machine learning engine 632 or one or more entities in the distinct ecosystems authorized to undertake an action on the one or more entities. Finally, notification 640 refers to the act of sending out an indication to an entity that has registered interest in a certain class of events. However, in some embodiments, the indication is only sent when a condition is fulfilled. The condition may be said to be fulfilled when the event exceeds some threshold in terms of the rate of the event or the attributes of the event that would indicate an anomaly that is worth investigating.

Object data store 626 refers to a database of objects. The schema of the objects is described later in the present specification. In an example, the object may relate to one or more items generated at the entities operating in the distinct ecosystems. In another example, the object may relate to one or more actionable items identified from the items generated at the entities, wherein the actionable items may refer to items on an event correlation map that require a response trigger. A CDC (Change Data Capture) arrow from object data store 626 to a stream processing engine 634 refers to a process that captures incremental changes from the object data store 626 and puts them on a logical queue for further processing using streaming algorithms at the stream processing engine 634.

A CDC+ component 630 is one of the consumers of the CDC data stream. The CDC+ component 630 performs multiple functions with the received CDC data stream. The link between CDC+ component 630 and the indexing module 622 refers to the process of creating an index of the objects in the object data store 626 for faster retrieval. As objects change, the CDC+ component 630 incrementally updates the information in the index. The arrow from the CDC+ Component 630 to the bulk store 624 refers to the process of archiving some or all of the objects in the object data store 626 for long-term storage. As objects are changed or updated, the updates are propagated to the object data store 626. The arrow from CDC+ component 630 to the analytics data store 628 refers to the process of using incremental updates of the object data store 626 to maintain the results of expensive analytics queries without re-executing them from scratch.

The CDC+ component 630 also allows for storage of enhanced version history which can be used for a variety of use cases including audit history, change invalidation/roll back and the ability to compose a snapshot of the unified analysis platform and/or object at a specific point in time. With these composable snapshots, the unified analysis platform can restore an object or data to a specific point in time for troubleshooting or roll back.

The embodiments of the present subject matter are compatible with all event types that are relevant for the functioning of a product/service. The event types may include, but not restricted to, (a) Development: Build, test, and deploy events from tools such as GitHub, GitLab, CircleCI, Artifactory, Envoy, and Istio; (b) Operations: Operate, and manage events from tools such as DataDog, Splunk, AppDynamics, NewRelic, Prometheus; (c) User: Customer engagement, including omni-channel communication (voice, video, email, chat), and events from social media, client browsers; and/or (d) CRM: Customer journey events including clickstream events from tools such as Salesforce, Pendo, Gainsight, Mixpanel, Adobe CDP, Clickstream and Segment.

The collected events may be clustered into incidents that are classified as good or bad. No human intervention is required for creating incidents. The presence of multiple similar events that occur close in time and or have similar content is sufficient to help create the incidents. The incidents are presented to one or more entities operating in distinct ecosystems authorized to undertake an action in relation to the incidents. Based on feedback by the one or more authorized entities, the notion of similarity may be tuned. The present subject matter is compatible with any notion of similarity, and the present subject matter may be implemented using any suitable similarity algorithms, such as for example, Bloom filters, vector space embeddings or other approximate matching algorithms such as edit distance, but it is not restricted to them.

Incidents are further clustered into tickets that are given a priority and assigned to the one or more authorized entities operating in the distinct ecosystems in relation to the tickets. Some embodiments of the present subject matter implement ticket clustering by considering an evidence trail, performing correlation between different types of incidents, and/or performing prioritizations. With regards to an evidence trail, the creation of a ticket is based on the clustering of multiple incidents which in turn are created from events. The generated ticket presents a clustering history as a justification of the ticket. The most relevant information from the events that are part of the ticket is included in the ticket to make triaging easier. For example, deployment related tickets may include snippets of logs, traces and alerts which are related. With regards to correlation between different types of incidents, incidents that are created in different parts of the software organization are correlated together when a ticket is created to ensure that it is assigned to the correct person and given the appropriate priority. For example, issues that are created from fatal errors in the operations ecosystem may be linked to login delay issues in the development ecosystem and these may in turn link to errors in testing that are in turn linked to code commit events. Thus, an assignment of a ticket to a developer-end entity can be explained in terms of the correlation between incidents. With regard to prioritization, any suitable type of prioritization may be used. For example, prioritizations may be based at least in part on revenue impacts. The correlation of incidents from the distinct ecosystems allows the determination of the impact of the incidents to entities operating in relation to the distinct ecosystems and based on billing data from the CRM entities, a revenue number is assigned to the ticket. This allows the priority to be directly linked to the software organization's revenue.

Finally, after a root cause analysis is performed by a triaging logic on the tickets, some of the tickets are combined into issues. An issue represents a recurring long-term failing in a product or service offered by the organization that needs a systematic redesign. The events, incidents, tickets, and issues that require a response trigger from the one or more entities operating in distinct ecosystems may be referred to as an actionable item.

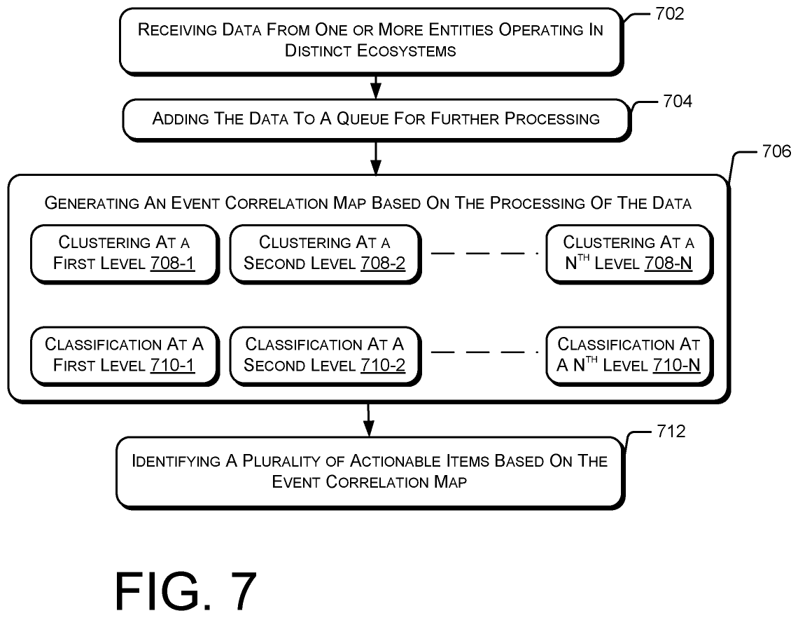

FIG. 7 shows a flowchart of an approach to perform cross-ecosystem analysis using machine learning in a unified analysis platform according to some embodiments of the present subject matter. At step 702, data from one or more entities operating in distinct ecosystems is received at a platform front-end. In an example, the platform front-end component of the unified analysis platform receives information from one or more entities operating in distinct ecosystems. In some embodiments, the unified analysis platform is implemented as a cloud service, e.g., using a software-as-a-service (SaaS) model, where the user of the service provided by the unified analysis platform is an organization that develops or manufactures a product for end users/customers. The unified analysis platform in the present specification, for the sake of explanation, has been implemented pertaining to a connected environment comprising distinct ecosystems pertaining to a single product. The platform front-end therefore may interface with sources of information from numerous distinct ecosystems, including developer-end ecosystems and/or user-end ecosystems.

At step 704, the data is added to a queue for further processing. In an example, the data is placed into one or more event queues for consumption by the machine learning engine for further processing. In the system architecture discussed in FIG. 6, the event queues may be located, for example, within stream processing engine 634. Different types of data may be processed using different queues. For example, the event streams for information collected by rover(s) (e.g., log data or stack traces) may be collected and placed into a first set of one or more queues for processing based upon “incident models”. In contrast, the event streams for information collected by the connectors (e.g., CRUD events or pipelines) may be collected and placed into a second set of one or more queues for processing based upon “entity models”.

At step 706, an event correlation map is generated based on the processing of the data. In an example, the processing may be performed using machine learning-based techniques. The processing may be performed by implementing a series of triaging logics implemented at different levels to funnel the data into more meaningful sets of analyzed data. The raw event data from the multiple distinct ecosystems correspond to an extremely large volume of data, which is analyzed in a unified way across the distinct ecosystems, and is used to form increasingly smaller and more meaningful sets of data.

At each granular level of the triaging, clustering 708 and classification 710 actions are performed upon the data. The clustering and classification actions may occur at multiple granular levels. While the FIG. 7 denotes clustering at a first level 708-1, clustering at a second level 708-2, clustering at a N^{th} level 708-N, classification at a first level 710-1, classification at a second level 710-2, classification at a N^{th} level 710-N, the same may not be construed as a limitation. In an example, the number of levels are determined based on a level severity of an item generated at each level. Clustering refers to the aggregation of multiple similar events or objects to a single meta-event or meta-object that captures some underlying commonality among these events or objects. A set of machine-learning based techniques may be used to perform clustering on the collected data, where the goal is to perform a unified funneling action upon data from multiple distinct ecosystems to identify items that require a response trigger from one or more entities operating in the distinct ecosystems, referred to as actionable items. Classification refers to the assignment of an attribute based on analysis of past actions undertaken by a machine learning algorithm or one or more entities operating in a plurality of distinct ecosystems.

The general idea is that event data from multiple distinct ecosystems may be received from entities inhabited by the distinct ecosystems, where clustering analysis is performed in a unified manner across that collected data such that cross-ecosystem analysis is performed upon that data. With regards to triaging, triaging logic is implemented at different levels of granularity, and each level of granularity reduces the overall data to a smaller and more meaningful set of data for the next level of granularity, and a different triaging logic may be used at each level of granularity.

At step 712, a plurality of actionable items may be identified based on the event correlation map. In an example, the transmission of an indication of the actionable item is performed to send out one or more messages to the one or more entities operating in distinct ecosystems. Each type of notification may be specific to a given entity that has registered interest in a certain class of events. For example, a first type of notification may be sent to the developer-end entities with regards to issues pertaining to software coding issues. A second type of notification may be sent to a user-end entity, who may be actually utilizing the deployed product.

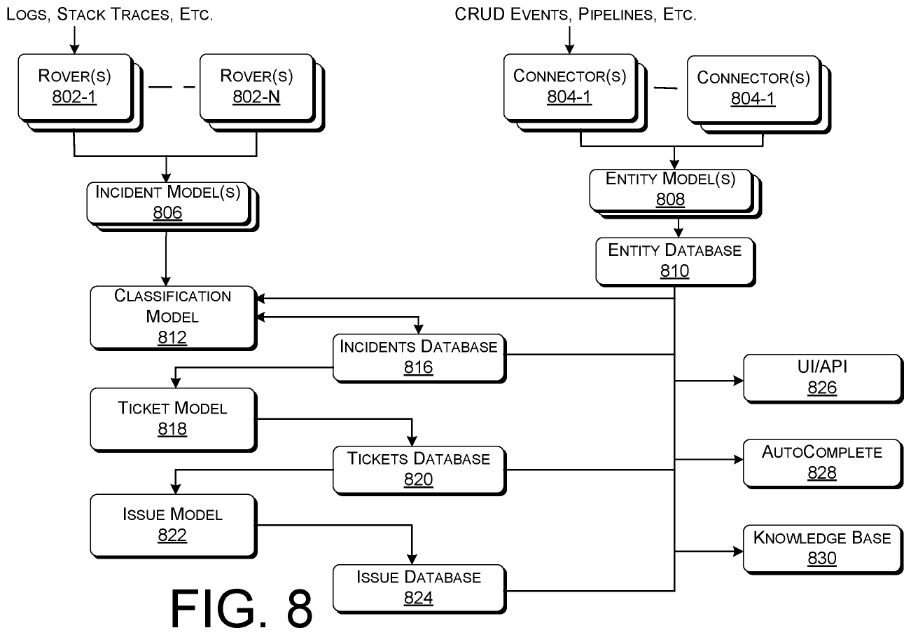

FIG. 8 provides an illustration of a machine learning (ML) architecture according to an example implementation of the present subject matter. One or more ML models implemented as a part of the ML architecture correspond to the machine learning engine in the system architecture discussed with respect to FIG. 6. Further, the processing of data streams captured from the one or more entities operating in distinct ecosystems may be implemented by the stream processing engine 634 with respect to FIG. 6.

In particular, one or more rovers 802-1, 802-N, collectively referred to as rover(s) 802, may collect data streams for information such as log data or stack traces that are provided for analysis to one or more incident model(s) 806. In contrast, one or more connector(s) 804-1, 804-N, collectively referred to as connector(s) 804 collects data streams for information such as CRUD events or pipelines that may be provided for analysis to one or more entity model(s) 808. In this embodiment, the connector(s) 804 are more focused on the entities, rather than the events that those entities are producing, e.g., for developer-end entities and user-end entities. As such, the information from the connector(s) 804 would be processed with respect to the entity model(s) 808. In some cases, a connector(s) 804 may include a rover(s) 802 as part of it, and thus the connector(s) 804 may produce a first stream of data from its rover(s) 802 for the incident model 806, and a second stream of event data for the entity model 808.

The data stream then undergoes both clustering and classification. The clustering operations will use a respective model to perform grouping operations on data objects based upon whether the data either looks similar or does not look similar to each other. Clustering may be operated at different granularity levels. For example, clustering may occur at the incident level using incident model(s) 806, at the entity level using entity model(s) 808, for classification using classification model 812, for ticket identification using ticket model 818, or to identify issues using the issue model 822.

The clustered data may then be further analyzed and augmented with more contextual information by performing classification upon the clustered data. The classification operations may, for example, classify the data into problem groupings or non-problem groupings. The classification operations may produce entity classifications that are stored in an entity database 810, incident classifications that are stored in an incident database 816, ticket classifications that are stored in tickets database 820, and issue classifications that are stored in an issue database 824.

Communications and/or notifications may occur at various points within an event correlation map. For example, a UI/API 826 may be used to communicate information to API users, or any other person in relation to the one or more entities operating in the distinct ecosystems. One or more auto-complete operations may be performed to automatically complete or update various external systems, fields, or entities. In addition, data and analysis results may be used to populate a knowledge base 830.

Regarding details of the processing by the ML architecture and the ML models, the incident models 806 read from multiple data streams pertaining to events and output to an incident stream. The incident models 806 learn to find the similarity between events of a certain kind so that they may be combined into an incident. In an example, the incident models 806 are responsible for clustering within data pertaining to a single ecosystem. Some examples may include: (a) reading test failure events over multiple test pipelines or within a single pipeline to determine that there is an test environment failure incident; (b) reading user tracking events from multiple users to determine that there is an incident whereby many users are seeing delays in logins; (c) reading operational alert events over time to determine that there is an incident whereby a service is not performing optimally; and/or (d) noticing a spike in the number of operational alerts above usual levels.

Similarities between events are learned by looking at events that occur closely in time and that are close in related objects. The incident model(s) 806 gets positive feedback when an incident is made part of a ticket or when an incident is not dismissed by an entity in relation to a set of hierarchical product parameters associated with the incident.

The incident model(s) 806 are trained automatically from the event streams that an entity is subscribing to in each of the distinct ecosystems. A specialized tokenizer can be used for each event stream to extract the most relevant tokens. An embedding layer is used to map the tokens in each event type to vectors. The embedding layer learns the pattern of tokens in each event and the sequence and co-occurrence of events to learn appropriate embeddings. This training is done without any manual intervention in some embodiments. An embedding model is produced that is saved persistently and relevant portions of it are cached as events are processed. A kNN (k nearest neighbor) indexing layer provides the ability to quickly find similar events.

The entity model(s) 808 reads from various systems of records associated with each entity in the one or more distinct ecosystems that provide information about the raw entities. The entity model(s) 808 deduplicates repeat mentions of entities across these systems of records and learns their relationships which are then all written out to the Entities Database 810. Some of the information that may be learned include: (a) which developers work in the dev organization; (b) what code repositories are owned by the dev organization; (c) which code files are part of these repositories; (d) which developer owns which repository/files; (e) which repository/file provides what code component; (f) what services are deployed; (g) who are the users and which entities do they belong to; (h) what products/capabilities/features are provided by the developer-end entities; (i) which user is signed up for which product/capability/feature; and/or (j) which product/capability/feature relies on what code component and which service is it deployed on.

The classification model 812 may also be referred to in some embodiments as an ML entity reference resolution model. The ML entity reference resolution model reads the incidents database 816 as well as the entity database 810 to identify which entities are referenced in each incident. Some examples may include: (a) which product/capability/feature is referenced in a user tracking incident at the user ecosystem; (b) which code component is referenced in a test failure incident; and/or (c) which ops service is referenced in an alert log incident.

The ticket model 818 reads from the incidents database 816 and determines whether a ticket should be created out of an incident. The ticket model 818 also determines whether some of the incidents should be linked together in the ticket. Some of the linkage examples may include: (a) determining that an incident related to slow logins captured from user tracking events in an event ecosystem is linked to the incident created from alert events captured from an operations ecosystem; and/or (b) determining that multiple test failure incidents are related to a single code commit. The ticket model 818 model is trained by identifying similar incidents that occur over a long period of time and also by manual intervention.

The issue model 822 links together issues that are related to a common underlying root cause in the product. The issue model 822 learns to distinguish between tickets caused by transient environment failures versus those caused by inherent flaws in the product itself. While tickets may describe problems being experienced by a single user-end entity, an issue may span all/multiple user-end entities and references the underlying product.

Correlation of events across the distinct ecosystems allows the assignment of appropriate severity and priority. Correlation across distinct ecosystems also allows for appropriate attribution of the actionable items identified from the events.

AutoComplete 828 may be implemented using an auto-completion model (not shown) that tracks all the fields that a user may enter in tickets and issues and learns to fill in these fields. The auto-completion model also learns to detect fields that are deprecated and should not be filled in as well as fields that are required to be filled in conjunction with other fields. The autocompletion model also clusters issue and tickets, and provides recommendations for similar issues and tickets to be linked. The autocompletion model also links appropriate incidents and events that may provide additional context for the ticket or issue. For example, log files for errors encountered in an operations ecosystem.

The Knowledge base 830 may be populated using a knowledgebase model (not shown) that identifies knowledgebase articles that are most relevant to an actionable item and suggests these to a unified analysis platform trying to identify actionable items from an event correlation map. The knowledgebase model autonomously creates knowledgebase articles based on common frequently occurring remedial steps that are undertaken by authorized entities in the one or more distinct ecosystems.

Some embodiments pertain to an object model to implement the invention. In the below description of the object model, the term “TechCompany” refers to an organization providing a product in relation to which a plurality of distinct ecosystems may operate in a connected environment, described herein. In the object model, various TechCompany terms may be employed. The term “dev org” refers to an entity operating in the connected environment. In the case of the entity being TechCompany itself, “dev org” will be its own dev org, and that of the user's “user org” would each be their own dev org. The term “dev oid” refers to the unique ID assigned to the dev org. In some embodiments, the TechCompany is assigned to a dev oid=0. The term “dev consumers” refers to the TechCompany's direct users. These are part of the Dev-org. The term “dev cid” refers to the unique ID assigned to the dev org's consumer. The term “dev cloud” refers to network connecting developer-end ecosystems operating in relation to the product and/or service.

The term “user org” refers to the TechCompany's consumer's consumer (account), which will be on boarded onto TechCompany by the dev org. The term “user oid” refers to the unique ID assigned to the user org. The term “user consumer” refers to the TechCompany's consumer's users, and are part of the user org. The term “user cid” refers to the unique ID assigned to the user org's consumer. The term “user cloud” refers to network connecting user-end ecosystems operating in relation to the product and/or service.

The term “rover” refers to a log/event collector which provides logs/events to the TechCompany platform. The rover can collect both machine or user generated items, and can inhabit the “Dev cloud”, “User cloud”, “TechCompany cloud” or external. A “connector” is used to synchronize entities between ecosystems. Connectors may synchronize objects bi-directionally in addition to creating objects in the source ecosystem.

The term “operational factor” refers to a component or piece of the hierarchy of operational factors associated with the product and/or service deployed in the connected environment. Exemplary operational factors include a particular capability, feature, microservice, component, and the like. The term “hierarchical product parameter” refers to an operational factor in the hierarchy of operational factors for a particular ecosystem of the connected environment. The term “actionable item” refers to any item of interest that triggers a response to be undertaken by one or more entities in the distinct ecosystems. Exemplary actionable items include: an event, an incident, a ticket, or an issue.

An “event” is a granular item of the data streams generated by the system, user, application, rover, etc., pertaining to entities operating in the distinct ecosystems in relation to a product. The data streams are commonly not of interest by themselves, however certain data in the data streams may be of interest (e.g., test failure, etc.), and may thus be termed as events. Exemplary events include: (a) alert; (b) stack trace; (c) test fail/pass; (d) system generated event (e.g., user CRUD, ticket creation, etc.).

An “incident” is used to group events by space and time into a clustered unit called an incident. Incidents are things of interest to entities deployed across ecosystem in a connected environment and are important for notification, however any action may not be necessary. For example, consider a critical error that occurs for a failed test. To gather context, one can look at relevant events leading up to the failure (e.g., user actions, logs, etc.) and cluster these together into an incident. In essence, an incident allows the system to gather context by combining relevant and related events and memorializing them with an incident (artifact).

Various terms in an object model may pertain to work management. The term “project” may pertain to an ephemeral/medium term series of work that exists as part of a product or service capability. For things that are longer running or require coordination/collaboration, it is preferable to create a project vs an unconnected issue. Objects that require phasing should be run as part of a project. For example, for a new release/version, the project may pertain to: (a) having associated issues for new features/bugs; (b) having associated marketing collateral, such as product collateral, website/digital updates, and/or documentation. The project may also pertain to the development of a new capability.

The term “issue” pertains to something requiring structural modifications, including modifications at backend constructs. For example, an issue may require back-office work (people writing code, etc.), and may relate to a new feature, a bug fix, etc. Some exemplary characteristics may include, for instance, duration of days/weeks/months, involving writing code (if development product), and/or having a higher impact/risk potential. Examples may include a new feature for a capability or a bug fix for a feature.

The term “ticket” pertains to something requiring cosmetic modification. For instance, the tickets may require front-office work. The tickets may be triaged to see if additional work/investigation is required. A ticket can be escalated/linked to an issue. Characteristics of the ticket may include some or all of: (a) Duration of minutes/hours; (b) Can be minor configuration/test changes; (c) Can be a minor activity (e.g., reset password); (d) Lower impact/lower risk potential. Examples may include a customer support ticket, or an auto generated ticket from ML.

The term “task” is a granular item of action performed by an authorized person and may be an action associated with resolution of a ticket or an issue. Examples may include peer review, Unit tests, etc.

Various terms in the object model may pertain to work management. With respect to a development project, the term “development repository” refers to a repository in a development ecosystem such as a source code repository. Examples include GitHub, GitLab, Git, etc. The term “version” pertains to a specific version cut from a branch at a specific time (commit). The version can be a release version or not. The term “branch” refers to a git branch that can be cut from another branch. The term “CI/CD” refers to Continuous integration/continuous deployment, which refers to the development methodology in which the development lifecycle and associated testing/push to product are much more automated/streamlined. Common tools have automated workflows/pipelines to handle testing and deployment. The term “test ecosystem” refers to an ecosystem where code is deployed, and tests are run.

Various terms in the object model may pertain to a hierarchy of operational parameters (e.g., for a product or service). A product is the highest level of the hierarchy of operational parameters and the parent of related capabilities and features (a hub or peak). Products typically have the following characteristics: (a) Units of revenue (have P&L); (b) Basis for contracts; (c) Level at which users are onboarded. A “capability” refers to a sub-unit of a product and is most commonly associated with the services a product provides. Capabilities typically have the following characteristics: (a) Services; (b) Unit of API scope; (c) Unit of licensing/pricing. An example is a TechCompany's work management service (ticketing, issues, etc.). A “feature” is a sub-unit of a capability and is typically something that the users can control via a flag or something they can experience indirectly. Features typically have the following characteristics: (a) Can be controlled via flags (e.g., on/off); (b) May or may not be visible to end user. Examples may include a TechCompany's work management services or automatic ticket creation, automated issue prioritization, etc.

At a physical level, a “microservice” can correspond to a generalized service or more granular “micro” service. The microservice typically directly maps to a Product's capability or feature which can be composed of one of more microservices. Microservices are a unit of functionality that is meant to be deployed independently and reused by multiple systems. Microservices typically have the following characteristics: (a) expose an API; (b) may be directly interacted with via an API/UI by the end customer; (c) may be published in a service registry/load balancer (Envoy, etc.). A “component” refers to a unit of functionality that is designed to be part of a system or application. A component corresponds to a library that can be used by multiple microservices. Components typically have the characteristics of support for various services though not commonly interacted with by the end customer. An “environment” may correspond to the client's operational environment (e.g., browser).

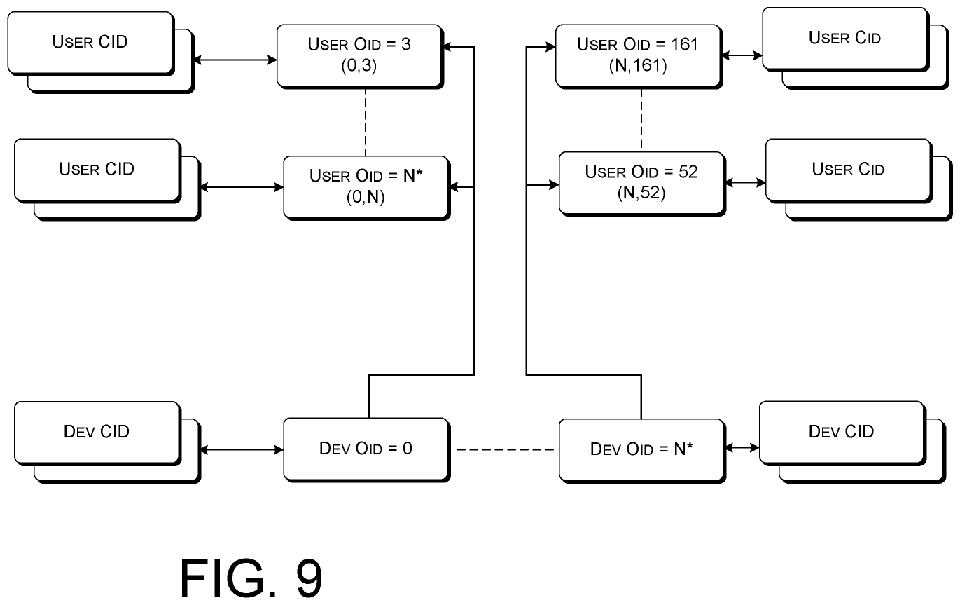

FIG. 9 shows an illustration of logical relationships that may exist between the orgs and users for Developer-end ecosystems and User-end ecosystems. TechCompany's users will have their dev_oid set to their user_oid. This will ensure that individuals will not get confused as their id (whether as TechCompany's User, or as its own Dev) is the same.

Operational factors relate to a piece of a product or service that has a lifecycle (ideation, prioritization, development, deployment, discovery, adoption, deprecation), and can be recursively made of smaller operational factors. Events and actionable items can be specific to any type of operational factors. An instance of an operational factor in a specific ecosystem of a plurality of distinct ecosystems may be referred to as a hierarchical product parameter.

The operational factors may have two core categories: user-end related operational factors and developer-end related operational factors. User-end related operational factors relate to hierarchical product parameters determining how the product is expressed, integrated, or consumed in the user-end ecosystem of a connected environment. User-end related operational factors may be purchased and interacted with by internal and external consumers. User-end related operational factors are primarily of three basic types: Product, Capability and Features. Further, internal facing User-end related operational factors like infrastructure services provided to support the product development and external facing user-end related operational factors which are consumed by an external user.

The code, service or components built or used by the developer are called developer-end related operational factors. A developer-end related operational factors may be a “runnable”, like a microservice or an executable. Runnable parts often expose APIs. A developer-end related operational factor may alternatively be a “linkable”, like a library or a component, which other developer-end related operational factors may depend on and use. Although the related operational factors often provide the functionality the entities of user-end ecosystems ultimately consume, they are often abstracted and unknown to the entities of user-end ecosystems.

FIG. 10 illustrates a conceptual schematic 1000 for the identification of an operational factor for a product deployed in a connected environment having a plurality of distinct ecosystems, according to an example implementation. In the first stage, a data extraction engine 1006 performs data acquisition from one or more entities operating in the plurality of distinct ecosystems in the connected environment for the product. The data extraction engine 1006 may utilize tools that may be separated the acquisitioned data into groups of information gained through parsing of code and information gained through correlation with metadata gathered from various systems. In an example implementation, information gained through parsing of code may include:
1. Code data, wherein the code data may be parsed to determine build tools which describe how the code is built. Such build tools are go.mod for Golang, maven for Java and requirements.txt for Python. Build tools describe the external and internal packages used in a code directory.
2. Deployment definition files, wherein the deployment definition files are used to define how code files and packages defined in the build tools are deployed. Common deployment definition files are docker, kubernetes and helm.
3. Deployment process files, wherein the deployment process files use a deployment definition and deploy this definition and its code. Such tools are CircleCI and Harness. Through the deployment process files, code can be automatically deployed, and the enclosed information can be processed by the organization/system that provides the Dev-Rev analysis/processing architecture.
4. APIs, their operations and parameters, wherein the APIs their operations and parameters are described and defined through common files. Popular API descriptor and generation tools are OpenAPI/Swagger3 for RestAPIs and Proto-files for gRPC.
5. Code files are at the heart of any code deployment and define how data is being processed, augmented and accumulated. Code files exist for different languages, such as Java files, Golang files and Python files. To detect what a piece of code is actually doing, the code file can be analyzed, either through source code tools or with Deep Neural Networks.

Further, information gained through correlation with metadata being gathered from various systems may include:
1. Version Control Software such as git allows to track the history of source code. The history of source code can explain when a file was created, what other files it was created from, and which other files were created or changed at a similar time.
2. Version Control Providers such as GitHub and BitBucket are cloud-based hosting services and give easy access to git functions. Version Control Providers store additional information and allow for easier parsing of version control history.
3. Continuous Integration tools open the possibility to integrate code and an automated basis and run automatic tests. Such tools are CircleCI and Harness.
4. Continuous deployment tools allow to automatically deploy code to different clusters. Such tools are again CircleCI and Harness.
5. Package Artifactories like JFrog, ECR and DockerHub are container image libraries that store a history of published containers. This allows to track container images through time.
6. Deployments, which define the way in which a product actually operates. Deployments can exist for compute environments and network environments. Compute deployment tools are EKS, Lambda functions and ECS, which define compute environments and the software they are running. Networking deployment tools are API Gateways, load balancers, DNS and Service Mesh. Networking deployments define how to interact with a compute deployment and how different compute deployments work together.

The acquisitioned data including groups of information gained through parsing of code and information gained through correlation with metadata gathered from various systems may be collectively referred to as programming files. The data extraction engine 1006 clones the programming files into temporary storage subsystems, goes over the repositories, directories, and files inside the code (crawling), and uses specific detection functions to analyze the different code parsing sources of information.

As distinct functions are used for each type of programming file, the logic of specific tools for each function can be used to analyze the programming files to gain information. A discovery engine 1008 may utilize detection functions to analyze the programming files to identify one or more constructs related to the programming files by detecting how code is parsed inside the entities operating in the distinct ecosystems of the connected environment and specifically how and which code files are used in the generation of binaries and their deployment. Through the API Description files, the discovery engine 1008 can also analyze how APIs are exposed to end clients. The data extraction engine 1006 then stores all collected information in an object data store 1014 for later analysis.

The data extraction engine 1006 may acquire data from three main input sources. The input sources are described above as metadata gathered from various entities. The first input source is code tools 1002 which are summarized in the information gained through parsing of code section above. Code tools 1002 may include build tools, deployment definition files, deployment process files, Application Programming Interface (API) descriptor files and code files. When extracting data from the code tools 1002, the data extraction engine 1006 also has access to the GitHub-related metadata such as the location, timestamps and commit-hashes of their GitHub commits. For example, data extraction engine 1006 can detect a build tools file and store the location and content of the build tools file, as well as the scope of code files the build tool files concerns. The data extraction engine 1006 may also detect the existence of an API descriptor file such as an OpenAPI file at one or more entities operating in the distinct ecosystems, for example, a user-end entity.

The second information source is metadata 1004 from dynamic sources, which are discussed in the metadata from various systems section above. The metadata 1004 includes data from Continuous Integration and Deployment tools, package artifactories, as well as compute deployments and networking deployments. The Continuous Integration and Deployment tools contain information about the deployment workflow of binaries and their images, and how these deployments are handled by package artifactories and the compute deployments. Through the networking deployment, images routed to API endpoints may be inferred.

In a second stage, the discovery engine 1008 loads the stored programming files, constructs and metadata, from the object data store 1014, accumulates and correlates their information to identify and discover operational factors and then identifies hierarchical product parameters across distinct ecosystems for the operational factors. Similar to the data extraction engine 1006, the discovery engine 1008 only runs in the context of the product. The discovery engine 1008 is used to extract information from the noisy data obtained by the data extraction engine 1006 by combining different signals to identify high-value signals. In an example, combining different signals to identify high-value signals means that the discovery engine 1008 links input sources across distinct ecosystems by detecting that a build tool is used in a deployment definition file and that this deployment definition file is itself used by a deployment process file. The discovery engine 1008 then accumulates, correlates, and combines the constructs extracted from each of the programming files to determine the one or more user-end related operational factors and the one or more developer-end related operational factors.

Alternatively, the discovery engine 1008 can also screen over API description files and networking files to identify the API operations described in these files, what parameters may be used by the discovery engine and how the parameters belong to similar features. The discovery engine 1008 then uses this information to bundle the API information into hierarchical product parameters that are produced by the API operations (and offered to the user-end related entities). Based on the above accumulation and correlation, the discovery engine 1008 hands the information over to an operational factors manager 1010, which saves the user-end related operational factors and the developer-end related operational factors in the object data store 1014. The user-end related operational factors and the developer-end related operational factors may hereinafter be collectively referred to as hierarchical product parameters.

In a fourth step, entities 1012 in relation to the hierarchical product parameters of the connected ecosystems may communicate with the operational factors manager. In this interaction, entities 1012 may create hierarchical product parameters, delete hierarchical product parameters, combine hierarchical product parameters, and add information to existing hierarchical product parameters for transfer of information in a hierarchy of operational factors. Through such interaction, entities 1012 not only generate the correct hierarchical product parameters for their organization but also provide the unified analysis platform with labeled training data and thus allow the unified analysis platform to learn and identify hierarchical product parameters in an improved manner.

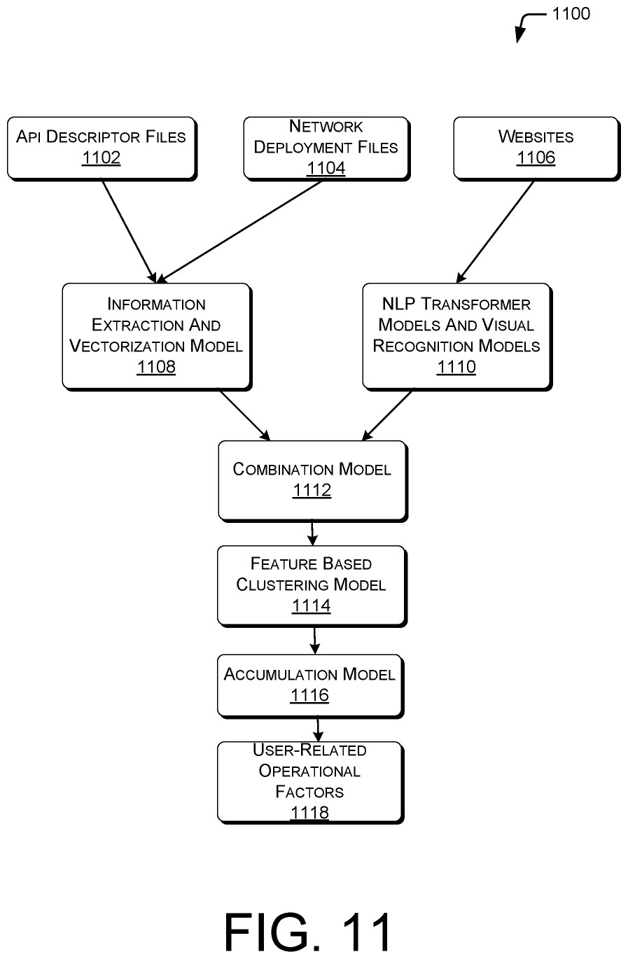

FIG. 11 illustrates a conceptual schematic 1100 for identification of a user-related operational factor for a product deployed in a connected environment having a plurality of ecosystems, according to an example implementation.

User-related operational factors cannot simply be detected from programming files, as they are abstract entities that may describe an organization's business model. The present subject matter discloses techniques to utilize Application Programming Interface (API) descriptor files 1102 containing structured information about the user-end entities API operations, and the information which nested API parameters, tags, descriptions and links are used for which API operation is extracted, by the data extraction engine 1006 through a specialized Parser function. The discovery engine 1008 then extracts and vectorizes the information using an information extraction and vectorization model 1108. For this vectorization step, the information extraction and vectorization model 1108 applies specialized Natural Language Processing functions that encode each API operation into a vector space, where similar API operations (as expressed by their attached information) have a similar encoding.

Another input source is data pertaining to websites 1106. In an example implementation, API descriptor files 1102 may determine which websites 1106 to scrape through to obtain the descriptive API file information and additional references throughout clients. The scraped websites contain the organization's API documentation, which is usually available online such that one or more entities deployed in the connected environment have a point of reference. The online API documentation typically contains text data stating which API paths and operations the organization exposes and which input and output parameters are related to an operation. The API documentation often also contains an implicit notion of how the API operations can be clustered, for example because different API operations occur under the same header. Besides simple text data, the information related to how the API operations can be clustered can also be conveyed in tables or images and website data to detect the user-related operational factors for a product deployed in the connected environment. In an example implementation, Natural Language Processing (NLP) Models and Visual Recognition models 1110 may extract the API operations from the websites 1106 and may transform the information into vectorized form. The NLP models and visual recognition models 1110 models use the data from websites 1106 as input and output a set of API operations and their vector encoding.

A third form of information comes from Network deployment files 1104. Network deployment files 1104, such as Kubernetes files, inform how API endpoints are routed to backend services and their images. The information from network deployment files 1104 may be obtained and vectorized, again using specialized NLP models to process the received information (in this case especially API path information) and vectorize it. Through the Network deployment files 1104, the unified analysis platform also has access to frequency, co-occurrence, and recency data, which is also used to identify related API operations.

In the next stage, a combination model 1112 combines the input information. In an example implementation, the combination model 1112 may be implemented by the discovery engine 1008. To do so, the combination model 1112 identifies duplicate received API operations and paths from the input sources and then combines the separate data sets. As the input sources were all mapped to vector spaces with the same embedding dimensions, and because the separate NLP models have all been trained to yield similar embeddings, all operations may simply be mapped to the same vector space in this stage.

In the next stage, a feature based clustering model 1114 groups the vectorized API operations into features. The feature-based clustering models may have the capability to be fine-tuned to follow a desired level of feature granularity and then identify the existence of a feature as a combination of API operations according to this level of feature granularity.

Next, an accumulation model 1116 accumulates information from the included operations to the cluster level—that is, from the API operations to the feature level. At this stage, the gained (non-vectorized) information may be simply combined for each API operation into a common data model and then accumulate summary information at the operation level. At this stage, the user-related operational factors 1118 may be identified and stored at an object data store.

As the identification of user-related operational factors 1118 is executed on a repeated basis and users have the ability to augment user-related operational factors 1118, their actions are saved such that the newly discovered user-related operational factors 1118 do not overwrite operational factors identified by manual intervention at the object data store.

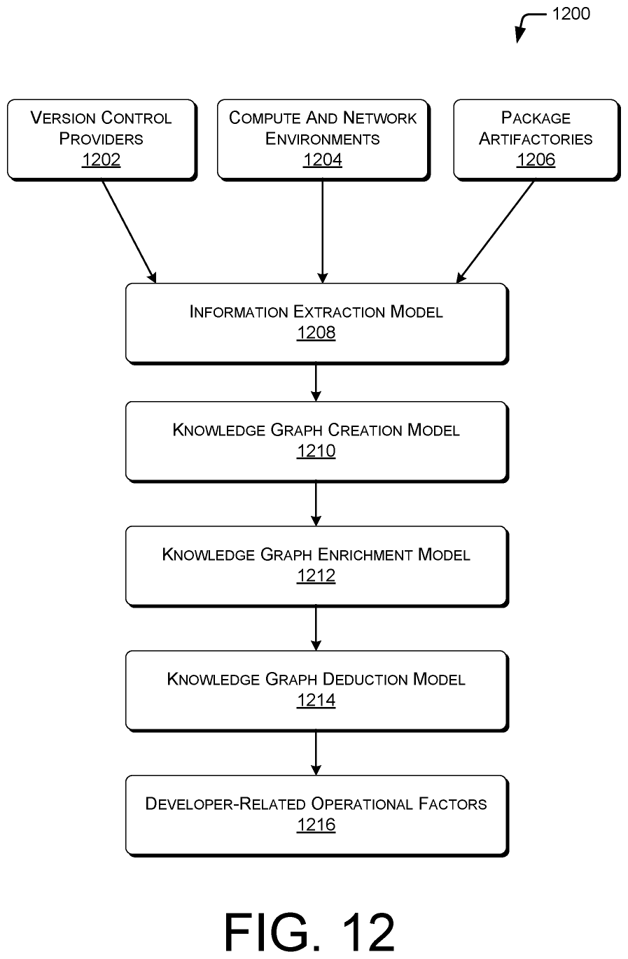

FIG. 12 illustrates a conceptual schematic 1200 for identification of a developer-related operational factor for a product deployed in a connected environment having a plurality of distinct ecosystems, according to an example implementation.

The techniques for identification of developer-related operational factors involve three main input sources. A first input source may be version control providers 1202 that may deliver code files, build tools and deployment definition and deployment process files as summarized in information gained through parsing code, as well as the files describing Continuous Deployment and Integration workflows, as discussed in relation to FIG. 10. Further, input data is gained from Compute and Network Environments 1204 such as the Compute and Networking Deployments and through Package Artifactories 1206, as explained in relation to extracting information on metadata gathered through various systems sections in FIG. 10. With these additional sources of information, a flow of container images, the locations where they are stored and the services that use them may be extracted.

The input data exists may be received structured, semi-structured and unstructured form. The information from the input data may be extracted through specialized functions performed by an information extraction model 1208.

The information extracted on the different steps in the package creation and deployment process is next used to create a knowledge graph using a knowledge graph creation model 1210. The knowledge graph has the programming constructs pertaining to build and deployment information as its nodes and connections between different deployment processes as its edges. The graph is constructed using syntactic knowledge about the different tools that are also used to extract the information from multiple input sources.

In a next step, the knowledge graph is enriched using a knowledge graph enrichment model 1212. Assuming that the information up to this stage is not complete, and there are missing edges between existing nodes. In an example, the missing edges may appear when the information extraction model 1208 extracts information related to a code, build or deployment tool that is not yet supported by unified analysis platform, when they use the tool in an atypical way that is not captured by the knowledge extraction algorithms. In another example, the missing edges may appear when the information extraction model 1208 does not have access to the source of information (either because the source does not grant access, or because the integration tool or missing or because it is not possible to extract this information). As behavior of the one or more entities operating the developer-end ecosystem and the steps used by the entities follow a probabilistic behavior—or at least can be captured by probabilistic models, and because it may be inferred that information is missing—and even which piece of information is missing—as the known syntactic workflow rules suggest this, the knowledge graph enrichment model 1212 has the ability to enrich the graph at this stage.

Next, the knowledge graph may be used by a Knowledge Graph Deduction model 1214 to identify the existence of developer-related operational factors 1216. The developer-related operational factors 1216 can be of different types—such as runnables and linkables—to embody the different purpose of software packages (e.g. runnables are the operational factors that actually expose a microservice through code and its deployed images, while linkables take the role of utilized libraries). To identify the existence of developer-related operational factors 1216, the node information may be passed along the constructed knowledge graph and use syntactic and probabilistic rules to identify developer-related operational factors 1216 being exposed by a node.

Similar to the user-related operational factors, the identified runnables and linkables, as well as the links between these two developer-related operational factor types, are then uploaded to an object data store. Therefore, manual augmentation actions to add the specified information to the developer-related operational factor may be avoided.

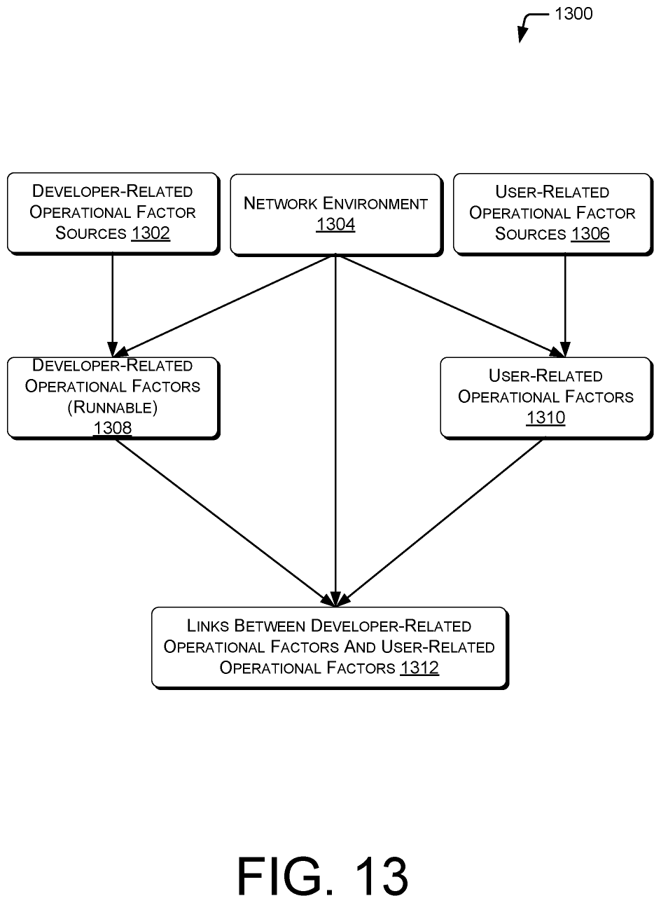

FIG. 13 illustrates a conceptional schematic 1300 for linking developer-related operational factors and user-related operational factors. A Network Environment 1304 (similar to network environment 1204, discussed in FIG. 12) and other developer-related operational factor sources 1302 are used to discover developer-related operational factors, specifically Runnables, using the techniques discussed above in relation to FIG. 12. Similarly, the Network Environment 1304 and other user-related operational factors sources 1306 are used to discover user-related operational factors, using the techniques discussed above in relation to FIG. 11.

Since the Network Environment 1304 is used to discover both developer-related operational factors 1308 and user-related operational factors 1310, the operational factors that are part of the same network environment may be linked across the distinct ecosystems. For example, if the network environment 1304 uses a backend name that was grouped with a developer-related operational factor 1308 (Runnable), and a connected API Path that was grouped with a user-related operational factor 1310, a link between the developer-related operational factors and user-related operational factors 1312 may be identified.

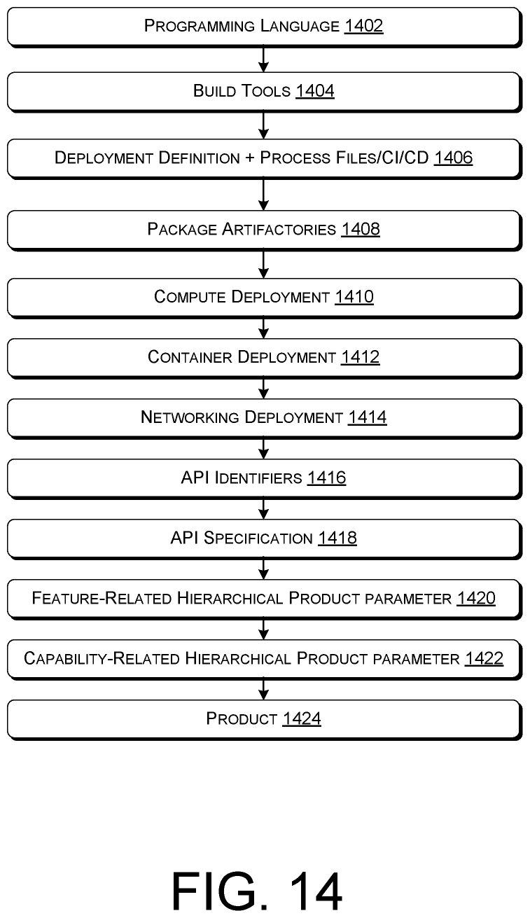

FIG. 14 provides a schematics of the full operational factors identification and linking of the operational factors across a plurality of distinct ecosystems.
1. Programming language 1402—The programming language 1402 used in a directory, e.g., go-lang.
2. Build tools 1404—The build tools 1404 used for the programming language 1402 in this location, e.g., Bazel methods (go_binary, container_image). The build tools help in mapping files in the repository contributing to a specific executable. This allows to support mono repos (repos that produce multiple executables), as several executables can be found in a single repository.
3. Deployment Definition+Processing File/Continuous Integration/Continuous Deployment file 1406, —The Deployment Definition+Processing File/Continuous Integration/Continuous Deployment file 1406 may include a Circle CI file that has the macro to publish to artifactory (docker push) thatHandles the actual deployment described in the Deployment Definition+Processing File/Continuous Integration/Continuous Deployment file 1406.
4. Package artifactories 1408, e.g., ECR, which contains the image list. The package artifactory 1408 is not found by exact correlation. Instead, heuristics based on timestamps, commit-id, and names are used.
5. Compute deployment 1410, such as Lambda or Kubernetes Container. The compute deployment 1410 can be identified by their image ID referring to ECR image. Therefore, a connection between the compute deployment 1410 and the code may be established.
6. Container deployment 1412 or compute deployment 1410 such as a Kubernetes Container being part of a pod, deployment, service. The Kubernetes Service exposes a host, port number.
7. Networking deployment 1414 linked to the image, such as a Load balancer. The Networking deployment 1414 can be identified as the load balancer has a routing rule to a URL prefix mapping to the Kubernetes Service. Now, links between network deployment 1414 and APIs may be established using URL prefixes.
8. APIs have operation ID 1416, http operation and parameters. The specific operation can be identified using the URL path.
9. API specifications 1418 describe the API complete API URL, including a URL prefix and the remaining URL path.
10. Feature-related Hierarchical product parameters 1420 map to a set of API operations.
11. Capability-related Hierarchical product parameters 1422 map to Feature-related Hierarchical product parameters 1420.
12. A Product 1424 may be a list of Capability-related Hierarchical product parameters 1422.

Developer-related operational factors are determined using the information for specific coding languages and deployment tools. Initially, a data extraction engine 1006 detects a coding language, such as Golang, and its correlated build tools, like bazel (these build tools inform where Golang binaries and container images are created). Using the build tools, files inside a specific repository and their contribution to a specific executable can be mapped. As this analysis does not define a single executable for each repository, but is instead location focused, mono repositories that produce multiple executables may be accounted for.

Next, deployment definition tools 1406 such as docker containers that use a specific build tool 1404 are detected, such that a build tool 1404 to deployment definition file 1406 link can be established. These files are then processed by detected deployment process files 1406 such as CircleCi, which has a macro to publish a docker image to a package artifactory 1408.

A CircleCi deployment is published to a package artifactory 1408 like ECR, which stores the list of published images. While the link between a deployment and an entry in ECR is not exact, timestamps, commit-ids and names allow for a heuristic-based identification. Using the ECR package artifactory 1408, a compute deployment 1410 such as AWS Lambda or a Kubernetes container can be identified which uses the image—for example, the image ID referring to the ECR image, which allows for a linkage of compute deployments 1410 and the code used.

For detected Kubernetes containers, the product, deployment, and service they belong to may be inferred. If the Kubernetes containers are part of a Kubernetes service which is a REST API object, a host and a port number may also be exposed. The API-exposing Kubernetes Service may be mapped to a load balancer, which has a routing prefix URL that maps to the Kubernetes service.

The API operation specified in a Swagger3 API specification file 1418 can be mapped to the API paths exposed by the load balancer. The Swagger3 file specifies additional information for each API operation that may be used to cluster the operations and map generated features that each map to a set of clustered API operations. Using additional user information, hierarchical product parameters related to features and capabilities may be generated, for example in a Trails View, and the features may be grouped to the hierarchical product parameters.

In certain cases, the operational factor identification may require further access to various data sources in a connected environment to make inferences and identify operational factors, such as the product's actual code, or their AWS and Kubernetes specifications. Since such information may be considered confidential, the aforementioned schematic is further configured to correctly identify developer-related operational factors and link them to their user-related operational factors, as explained under.

Users of the product may link an account for their favored version control system, such as GitHub, to the one or more entities operating in the connected environment. In such cases, a unified analysis platform receives live information from the version control system, such as information on their Branches on Pull Request. Branches actions and Pull Requests can be associated with actionable items. Git Snap-in allows a system for operational factor identification to better detect developer-related operational factors while they are being developed and link them to their related user-related operational factors. This enables linking developer-related operational factors and user-related operational factors faster and detect if events recorded in a version control system like GitHub qualifies as an actionable item based on in-app actions.

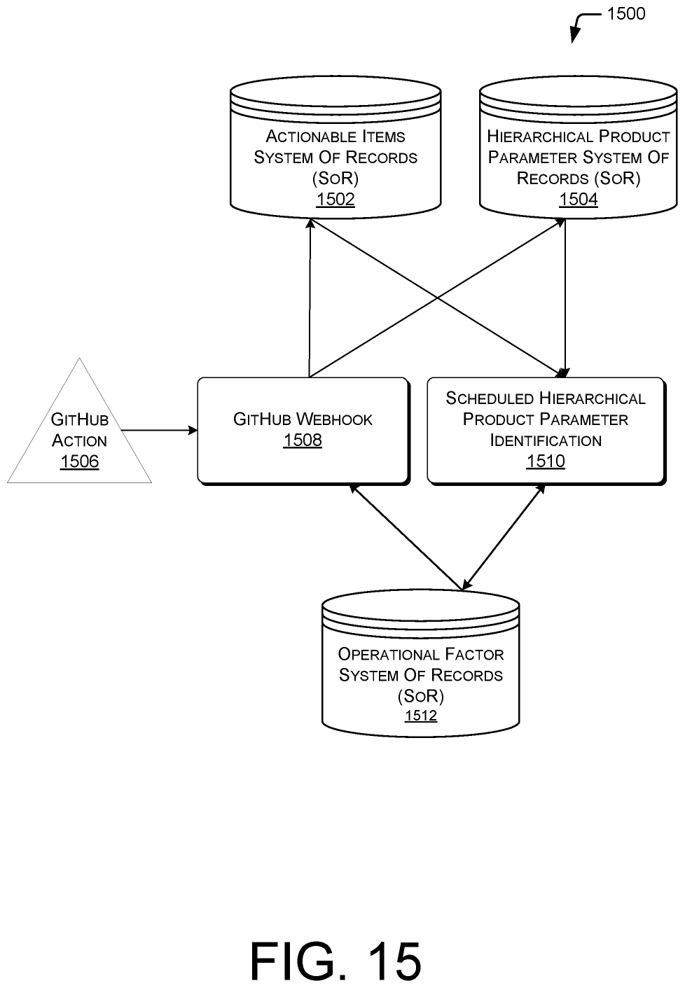

FIG. 15 illustrates a schematic overview of the event workflow 1500 during identification of operational factors through external version control systems. For ease of explanation, the workflow is explained according to version control system deployed at a GitHub Platform, however the same shall not be construed as a limitation. Initially, records of one or more activities referred to as GitHub action 1506 performed on the GitHub Platform may be generated. GitHub webhook 1508 listens to certain GitHub actions 1506 (which qualify as events), such as branch pushes, Pull Requests being opened or edited, and the like. The GitHub webhook 1508 is also informed about linked actionable items (explained in detail with respect to FIGS. 1 and 2), either because they are auto created for the GitHub actions 1506, or through some other link (for example the branch name or PR description can contain the issue ID). Further, operational factor system of records (SoR) 1512 may be fetched. If there exists at least one developer-related operational factor in the operational factor system of records (SoR) 1512, it may be denoted that the actionable items were developed with these developer-related operational factors. Else, it may be determined that the actionable items may require to contain action on the repository in actionable items system of records (SoR) 1502.

A discovery engine, such as the discovery engine 1008 discussed in relation to FIG. 10 fetches information on which hierarchical product parameters may be assigned to the actionable items, at step 1510. If it deems the actionable item is sufficiently important, based on the assigned hierarchical product parameters, and the relative and total amount of actionable items associated with an entity authorized to undertake an action on the assigned hierarchical product parameter, a set of hierarchical product parameters and associated actionable items may be created and stored at a hierarchical product parameter system of records 1504. Further, a link between user-related operational factors to which the actionable items may be related to, and one of its higher level linked user-related operational factors—and an associated developer-related operational factor may be established. At runtime, one or more of the sets of hierarchical product parameters and associated actionable items may be utilized to implement one or more aspects of the present subject matter.

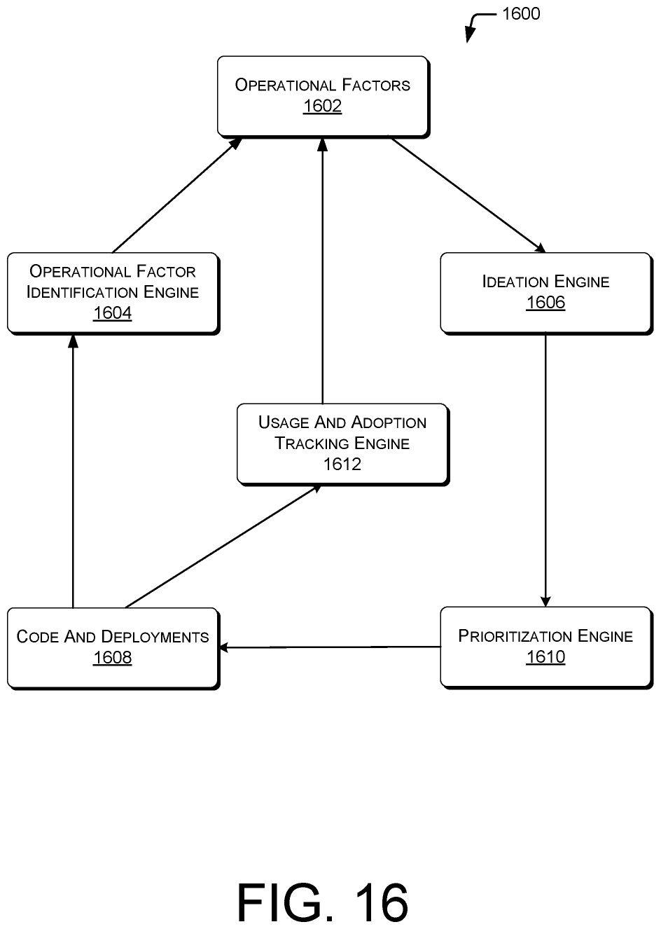

FIG. 16 illustrates a conceptual schematic 1600 for ideation and prioritization of hierarchical product parameters in relation to the identified operational factors associated with one or more entities operating in a plurality of distinct ecosystems in a connected environment.

The operational factors 1602, associated with a particular entity operating in the connected environment, identified using operational factor identification engine 1604 may help ideate new hierarchical product parameters, using an ideation engine 1606, and prioritize associated actionable items, using prioritization engine 1610. Further, user engagement with and usage of user-related operational factors, specifically feature-related hierarchical product parameters of the operational factors, identified by usage and adoption tracking engine 1612 may be used to determine usage and revenue metrics that provide more information to related developer-end entities, and thus help in identification of the operational factors 1602. The actionable items may be prioritized by the prioritization engine 1610 and translated into code and deployments 1608—which serves as a source for further identification of operational factors by the operational factor identification engine.

All metrics associated with the operational factors, such as the above-described usage metrics, but also metrics on deployments and actionable items associated with the entities operating in the connected environment, are presented in a Trails interface, which provides an intuitive way for the entities to interact with their hierarchical product parameters and gain insights into the architecture associated with the operational factors they may be authorized with.

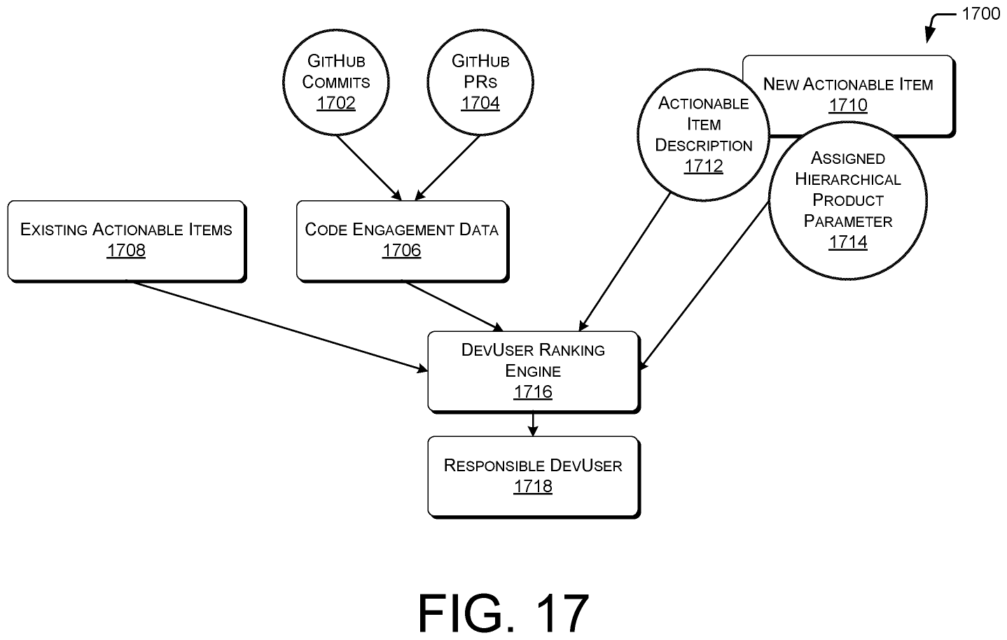

FIG. 17 illustrates a conceptual schematic 1700 for linking DevUsers to hierarchical product parameters and providing auto-assignment options.

DevUsers mainly engage with the hierarchical product parameters in two forms: performing actions on actionable items (issues or tickets) that may occur at a user-end entity operating in the connected environment. Through these actions, the user-related operational factors a DevUser interacts with—and by consequence also which linked developer-related hierarchical product parameters acted upon may be identified.

Further, a Code engagement data 1706 may be extracted to track which entities work on code that form a assigned hierarchical product parameter 1714 related to a new actionable item 1710. For example, code engagement data 1706 may be extracted through data on GitHub commits 1702 and therefore, the GitHub IDs which have committed to the new actionable item 1710 may be identified. Further, GitHub Pull Requests (PRs) 1704 may be tracked to determine their engagements such as, the GitHub IDs that have created, commented on, or reviewed the PR. Since it is known which DevUser IDs are associated with which GitHub IDs, and which files constitute developer-related hierarchical product parameters, the code engagement of DevUsers and developer-related hierarchical product parameters, as well as their linked user-related operational factors may be identified.

DevUsers and their relationships with operational factors may be used in different ways. An important such function is the autosuggestion of DevUsers when creating an actionable item. When a new actionable item 1710 is identified, related hierarchical product parameters 1714 have to be assigned to a user-related operational factor. Since it may be already identified which DevUsers have worked on this user-related operational factor, a set of the assigned hierarchical product parameter 1714 and the associated actionable item 1710 therefor may be transmitted to a DevUser ranking engine 1716 that auto-suggests the responsible DevUser 1718 for the assigned hierarchical product parameter 1714. In an example implementation, the set of the assigned hierarchical product parameter 1714 and the associated actionable item 1710 therefor includes an actionable item description 1712. For further context, the DevUser ranking engine 1716 also receives the existing actionable items 1708 with the operational factors as an additional input.

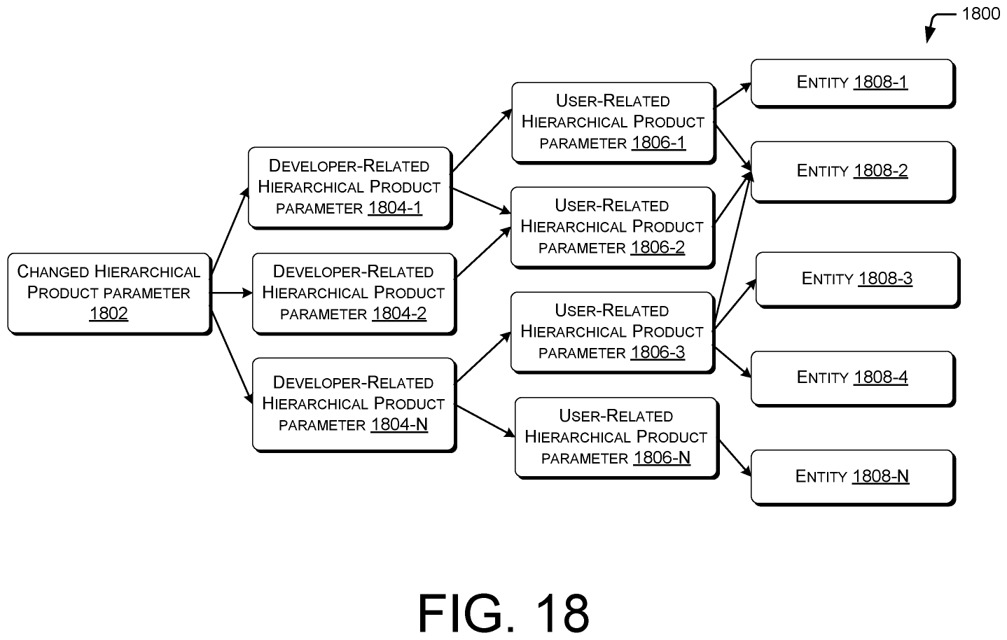

FIG. 18 provides a conceptual schematic 1800 determining a link between developer-related hierarchical product parameters and impacted user-related hierarchical product parameters.

A changed hierarchical product parameter 1802, wherein the changed hierarchical product parameter is a developer-related hierarchical product parameter, (for the sake of explanation) may be linked to other developer-related hierarchical product parameters 1804-1, 1804-2, 1804-N (for example when a Runnable uses a Library). The developer-related hierarchical product parameters 1804-1, 1804-2, 1804-N are linked to user-related hierarchical product parameters 1806-1, 1806-2, 1806-3, 1806-N (when a user-related hierarchical product parameters is serviced by a runnable) and user-related hierarchical product parameters 1806-1, 1806-2, 1806-3, 1806-N can be linked to other entities 1808-1, 1808-2, 1808-3, 1808-4, 1808-N (for example when a feature is a child of a capability). These links are automatically generated by a discovery engine, explained in respect to FIG. 10, and further enhanced through manual intervention.

Since a system of the claimed subject matter knows how hierarchical product parameters are linked, these links may be used to provide an Impact Analysis that informs entities which other developer-related hierarchical product parameter and user-related hierarchical product parameters will be affected by a change of another hierarchical product parameter. While classic Impact Analysis only asks which other code bases or features will be affected by a change in the code base, the system can also evaluate the impact of a change on a hierarchical product parameter that is used as a provider for other hierarchical product parameters. Therefore, the full impact on the product deployed in a connected environment can be evaluated.

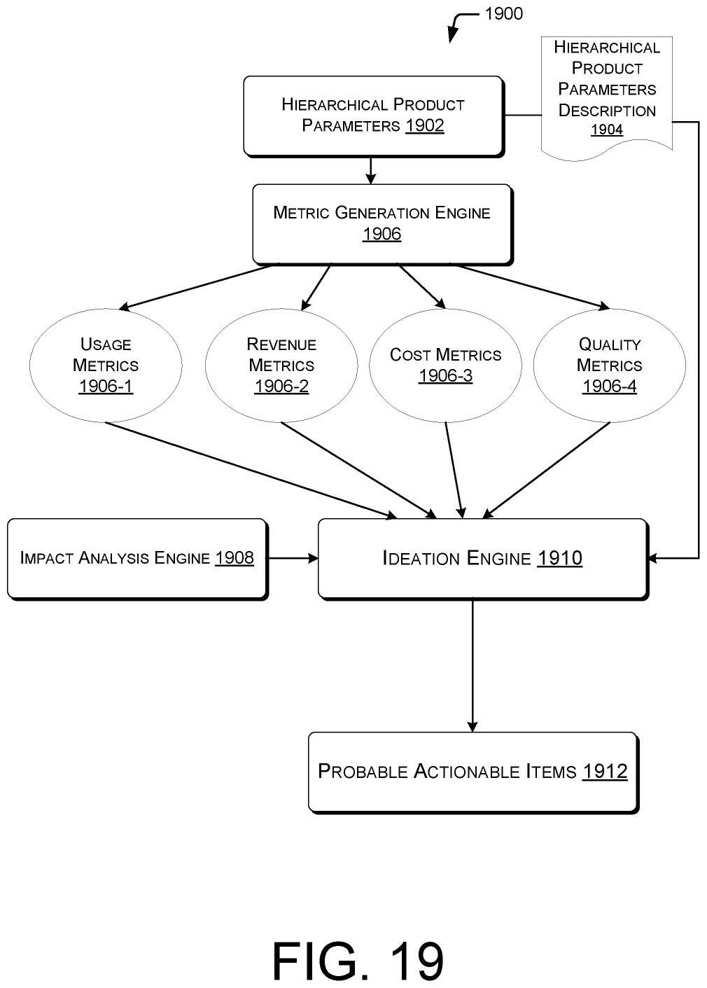

Since relationships between one more entities and the hierarchical product parameters they consume are known—both on an individual and an aggregated level (explained in detail with respect to FIG. 19), entities 1808 (and which revenue streams) affected by the changed hierarchical product parameter 1802 may be identified. This allows evaluating the impact of a code or deployment change on the business value of associated entities 1808.

FIG. 19 illustrates a workflow 1900 for ideation of actionable items, based on hierarchical product parameters.

To suggest new actionable items for a product deployed in a connected environment, metrics associated with the hierarchical product parameters 1902 and associated hierarchical product parameters description 1904 are generated by a metric generation engine 1906. The metrics may be, for example, usage metrics (how often the hierarchical product parameters are used; how many and which entities use the hierarchical product parameters) 1906-1, revenue metrics (what is the revenue a user-end entity authorized for the hierarchical product parameter currently generates) 1906-2, cost metrics 1906-3 (what cost does the product currently occur for an associated developer-end entity or user-end entity), and Quality metrics 1906-4 (how often does this hierarchical product parameter malfunctions).

For each hierarchical product parameter 1902, the metric generation engine 1906 tracks the following metrics:
Usage metrics 1906-1—Metrics related to which API Operations are used as the hierarchical product parameters for the operational factors, and since API Operations are contained in feature-related hierarchical product parameters, the features used by the user-end entities authorized for the operational factor may be identified. Usage metrics are collected for all operational factors and passed through links between user-end operational factors and developer-end operational factors.
Revenue metrics 1906-2—API operations are associated with prices (either directly when paying per operation or indirectly when paying via a monthly subscription). Since user-end operational factors may be determined, revenue accumulated by the user-end operational factors may be determined.
Cost metrics 1906-3—Since deployments may be associated with Runnables, Runtime costs generated by the Runnables may be identified and attributed to the linked user-end operational factors. Through tracking the actionable items of developer-end entities and the user-end operational factors they are assigned to, it may be monitored how costs occur at user-end entities (and their linked developer-end entities) at the developer level.
Dependency metrics (not shown)—As the build tools of the hierarchical product parameters are known, the (external or internal) packages used by the developer-related hierarchical product parameters may be inferred and can insights into this information may be offered.
Quality metrics 1906-4—The availability and latency of operational factors in the product may be identified, for example by evaluating the time it took to complete an API call, or by monitoring the downtime of a service. Further, logs and error messages associated with the hierarchical product parameters may be tracked, such that metrics on errors occurring for the hierarchical product parameters may be identified.

Further, data on the effects (in terms of the above metrics) of previous modifications, obtained using impact analysis engine 1908 is used as a second source of input. The data on effects for example shows that a specific modification of a hierarchical product parameter resulted in a 10% increase in retention for this hierarchical product parameter by a user-end entity or decreases the latency of a hierarchical product parameter by 15%.

The two data sources are passed to an ideation engine 1910. The ideation engine 1910 may use a generative Machine Learning based model to suggest probable actionable items 1912 to enhance the hierarchical product parameters. The output of the ideation engine 1910 is then presented in the form of probable actionable items 1912 that an organization that has developed the product deployed in the connected environment may use for its next development cycle planning.

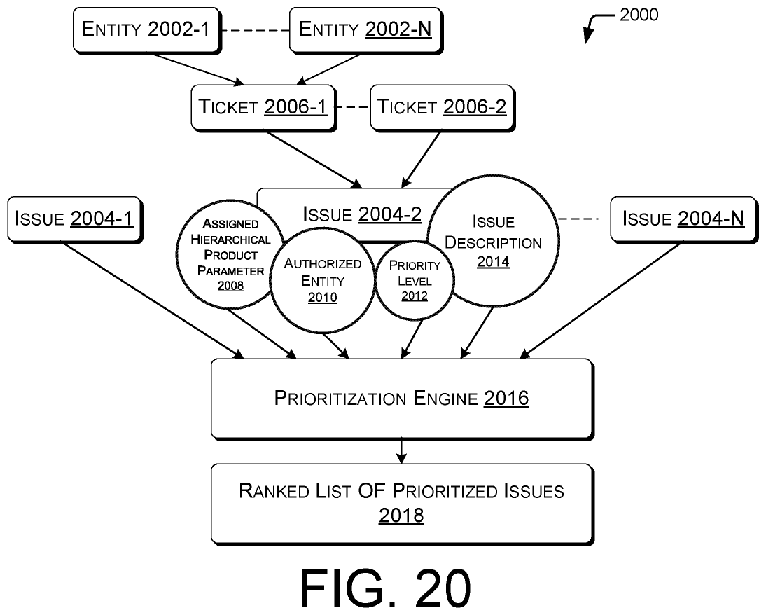

FIG. 20 provides a schematic illustration 2000 for prioritization of the actionable items. Developers are typically faced with an abundance of actionable items to focus on. To combat this overload the actionable items may be prioritized by the order in which they should be completed.

Prioritization may be explained herein with respect to the issue 2004-2 (an example of identified actionable items generated by one or more entities 2002-1, 2002-N operating in a connected environment for a product) that can be linked to other issues 2004-1—such as issues 2004 they are dependent on—as well as tickets 2006. Tickets 2006 can be filed when an entity 2002 requests a change of a hierarchical product parameter they are interacting with, and multiple tickets 2006 can be associated with a single issue 2004-2. Besides information from the issue-ticket hierarchy, the issues 2004 may also contain information related to their assigned hierarchical product parameters 2008, authorized entity 2010 associated with entities 2002 operating in the connected environment, their priority level 2012, and the issue description 2014. Issues 2004 are further subscribed with metrics, such as usage metrics, revenue metrics, dependency metrics, or quality metrics that can offer further insight.

All this information related to each issue 2004 is forwarded to a prioritization engine 2016. The prioritization engine 2016 may be a Machine Learning-based engine that prioritizes the issues through ranking, adjusting the order based on the potential and importance associated with an issue (for example, the potential revenue or number of entities that can be gained with this issue; the revenue or number of entities lost while not completing this issue), workload (based on the description and subtasks, the prioritization engine 2016 may compute a time till completion estimate), its dependencies (if an issue depends on another issue, they must be completed in the correct order), and the entities authorized for the issue (entities should work at a limited amount of issues in a single time period). The prioritization engine 2016 then outputs a ranked list of prioritized issues 2018. Further, upon identification of a subsequent issue (not shown), the issue may again be forwarded to the prioritization engine 2016 to update the ranked list of prioritized issues 2018 based on impact of the subsequent issue.

A microservice for the deployed product does not stand on its own. Instead, it occurs along with data pertaining to code, build files, test files, deployment files, and interaction with entities deployed in the distinct ecosystems. Therefore, when the importance of a microservice for the overall company (general ranking) may be determined, information pertaining to a group of people such as developers, product managers, management, and executives (grouped ranking) or an individual DevUser (user-specific ranking), may be taken into account. For example, microservices that are connected to all of these follow-up tools can gain a higher level of importance and therefore gain a higher level of visibility. Such different sources of information may be used to establish closeness-relationships between different microservices and other operational factors and use them for individual rankings. For instance, if it is known that a product manager is interested in a hierarchical product parameter that a specific entity group interacts with and it is also known that this entity group interacts with a hierarchical product parameter, then the second operational factor can attain a higher ranking score for this product manager.

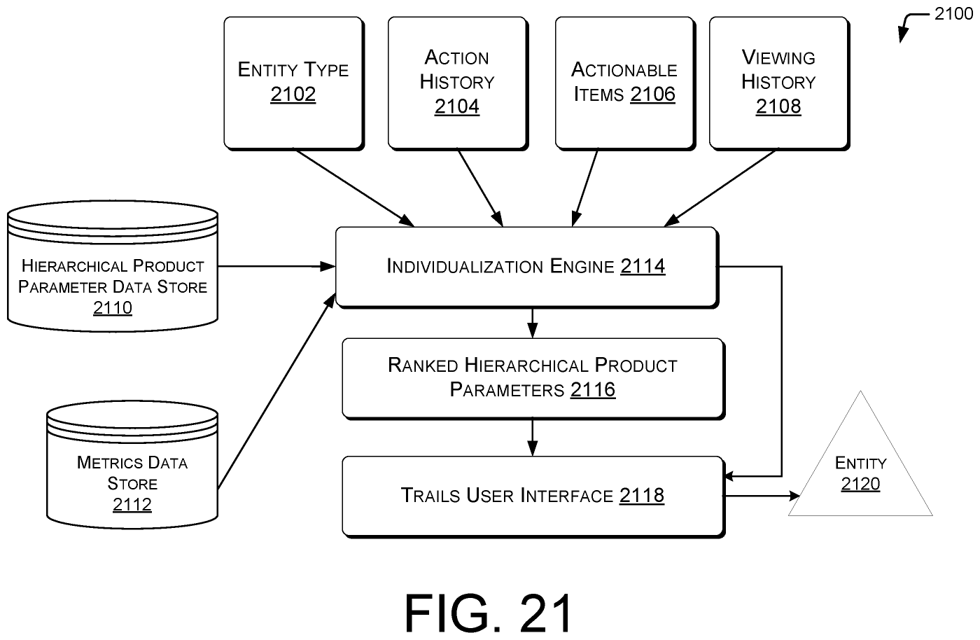

FIG. 21 illustrates a conceptual schematic 2100 for individualization of hierarchical product parameters associated with a particular entity from amongst one or more entities operating in distinct ecosystems.

Ranking of hierarchical product parameters and resulting individualization is important whenever users only want to see hierarchical product parameters relevant to them. Therefore, individualization is needed to limit the depth (e.g., number of hierarchical product parameters from each operational factor shown on screen) of the visual parts output information.

Besides simply ranking operational factors, the metrics associated with hierarchical product parameters may also be ranked. When ranking different metrics by their relevance to a given entity, the category of the metric and a representation of the metrics' importance/relevance is determined by a level of abnormality of the metric score.

Individualization depends on two aspects: entity-based aspects and class-based aspects. Class aspects are, for example, the type of a entity 2102 (e.g. a developer is interested in different hierarchical product parameters than a product manager and wants to view different metrics), but also the hierarchical product parameters' importance for an entire organization for which the product is deployed in a connected environment, while entity-based aspects, such as the action history 2104 related to a log of actions undertaken by the entity, actionable items 2106 that may have been worked upon by the entity have worked on or are currently working on and a entities viewing history 2108 provide information on an individual level.

Using these aspects, an Individualization Engine 2114, which is a recommender system that attributes relevance score to the hierarchical product parameters and the associated metrics, ranks them according to those scores and outputs a concise and personalized view of a hierarchical product parameters architecture for a particular entity and associated metrics through a list of ranked hierarchical product parameters 2116. The hierarchical product parameters to be ranked are obtained from a hierarchical product parameter data store 2110, and the associated metrics may be obtained from a metrics data store 2112. This view of the hierarchical product parameters architecture for the particular entity and associated metrics is then displayed at a trails user interface 2118. Based on the interaction of the entity 2120 with the shown hierarchical product parameters and metrics the entity's interests can be better learnt, and predictions may be improved. The architecture of the Individualization Engine 2114 may include a standard Feed-Forward Deep Learning architecture that transforms an n×1-dimensional vector input into a single score variable that summarizes the user's interest in the hierarchical product parameters.

The Trails User Interface 2118 is a graphical user interface that shows hierarchical product parameters, hierarchy of operational factors related thereto, and dependencies, as well as additional information on these hierarchical product parameters, such as their metrics or attached items.

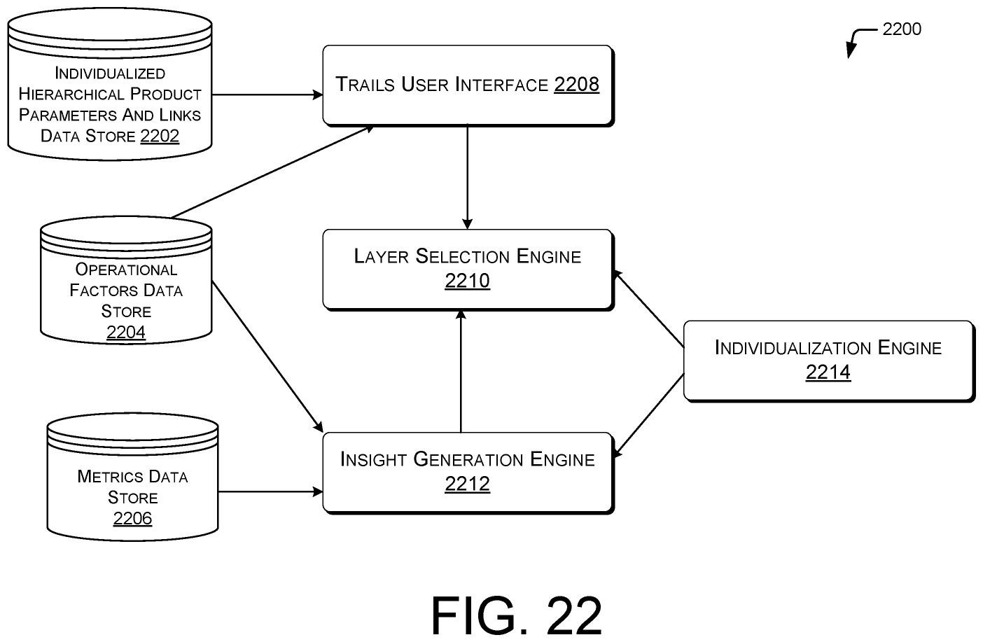

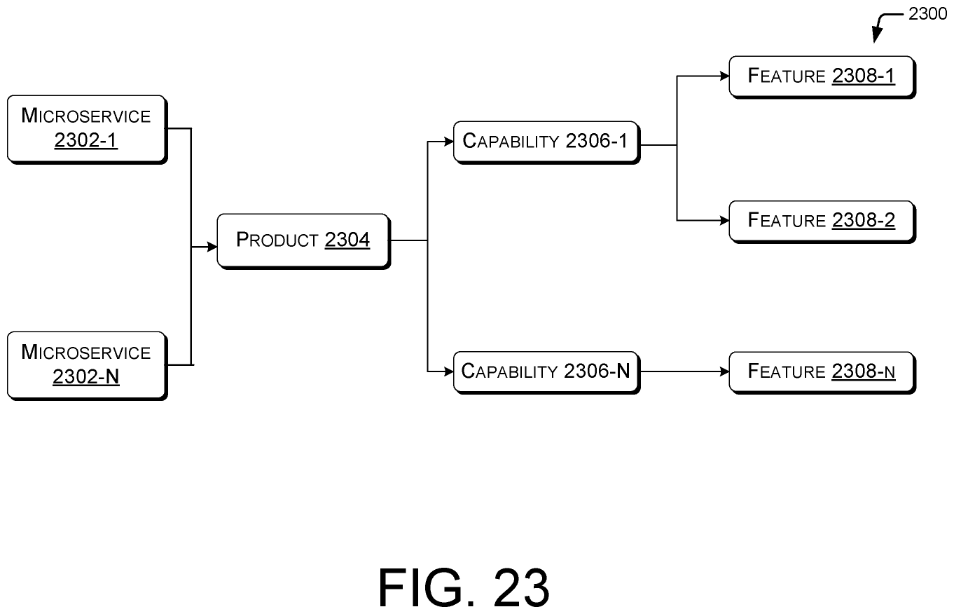

FIG. 22 illustrates a schematic overview 2200 of insight generation on a trails user interface. The Trails User interface 2208 loads the lists of individualized hierarchical product parameters and links from data store 2202, as well as their metrics from metrics data store 2206 and additional information, such as related operational factors from an individualized hierarchical product parameters and links data store 2204. The individualized hierarchical product parameters are displayed as boxes with lines connecting them according to their links as illustrated in FIG. 23. The hierarchical product parameters are further horizontally divided into vertical groups representing their operational factors, e.g., a group for capabilities, features, and so on.

Additional information on the hierarchical product parameters, such as their metrics, is accumulated in an insight generation engine 2212, processed and displayed through different layers. Users can select which layers to view, using a layer selection engine 2210, and the layers modify the graphical display, for example by changing the size or color of a hierarchical product parameter box. The full set of the displayed hierarchical product parameters and the layers form the Trails UI 2208. Users can also select to add some of the actionable items directly to the trails UI 2208, for example by opening a ticket inside Trails. To enhance the insight-generation and layer-selection experience, the individualization engine 2214 may be used to select which items should be displayed in a default view and trains the layer selection engine through feedback gained from user interactions with the layers.

FIG. 23 illustrates a schematic view 2300 of the trails user interface according to an example implementation. In the example implementation, the trail user interface 2208 may be displayed in the schematic view 2300. The schematic view 2300 may illustrate the connections between hierarchical product parameters, such as microservice 2302-1, 2302-N, product 2304, capability 2306-1, 2306-N, and features 2308-1, 2308-2, and 2308-N, displayed as boxes with lines connecting them according to their links.

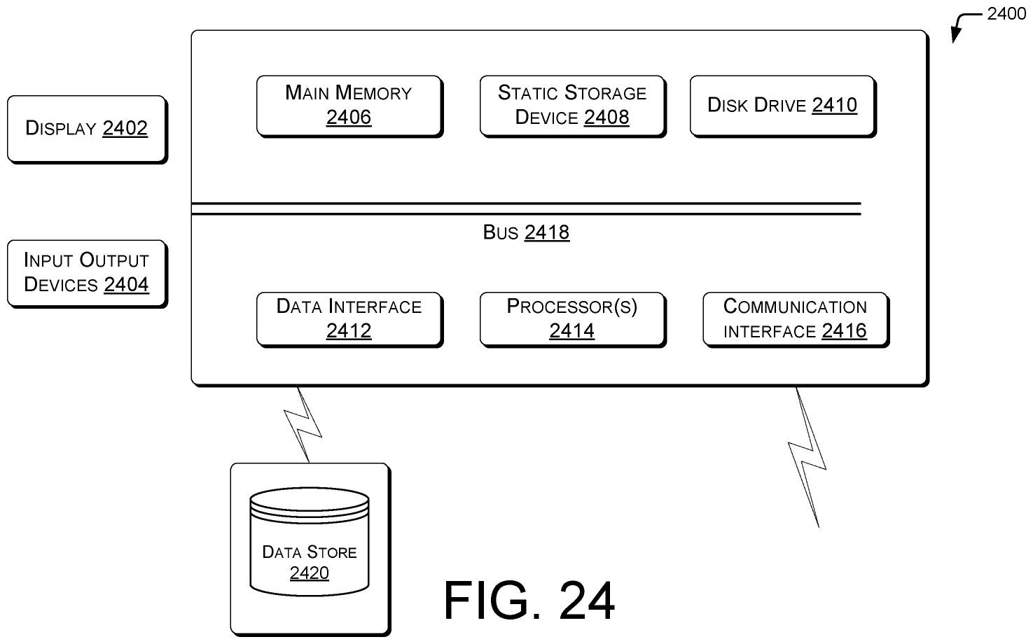

FIG. 24 is a block diagram of an illustrative computing system 2400 suitable for implementing an embodiment of the present invention. Computing system 2400 includes a bus 2418 or other communication mechanism for communicating information, which interconnects subsystems and devices, such as processor 2414, main memory 2406 (e.g., RAM), static storage device 2408 (e.g., ROM), disk drive 2410 (e.g., magnetic or optical), communication interface 2416 (e.g., modem or Ethernet card), display 2402 (e.g., CRT or LCD), input device 2404 (e.g., keyboard, and cursor control).

According to one embodiment of the present subject matter, the computing system 2400 performs specific operations by the processor 2414 executing one or more sequences of one or more instructions contained in main memory 2406. Such instructions may be read into main memory 2406 from another computer readable/usable medium, such as static storage device 2408 or disk drive 2410. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor 2414 for execution. Such a medium may take many forms, including but not limited to, non-volatile media and volatile media. Non-volatile media includes, for example, optical or magnetic disks, such as disk drive 2410. Volatile media includes dynamic memory, such as main memory 2406. A data store 2420 may be accessed in a computer readable medium using a data interface 2412.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 2400. According to other embodiments of the present subject matter, two or more computing systems 2400 coupled by communication link (e.g., LAN, PTSN, or wireless network) may perform the sequence of instructions required to practice the invention in coordination with one another.

Computing system 2400 may transmit and receive messages, data, and instructions, including program, i.e., application code, through communication link and communication interface 2416. Received program code may be executed by processor 2414 as it is received, and/or stored in disk drive 2410, or other non-volatile storage for later execution.

In the foregoing specification, the present subject matter has been described with reference to specific embodiments thereof. It will, however, be evident that various modifications and changes may be made thereto without departing from the broader spirit and scope of the present subject matter. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A system to identify an actionable event for a product deployed in a connected environment having a plurality of distinct ecosystems, the system comprising:
a processor to:
extract, for the product, an event correlation map in relation to a plurality of events generated by the plurality of distinct ecosystems, wherein an event is indicative of an activity at one or more entities operating in the plurality of distinct ecosystems;
identify a plurality of actionable items based on the event correlation map, wherein an actionable item is a response trigger associated with one or more events from amongst the plurality of events;
deduce correlations among the plurality of actionable items;
identify, based on the correlations, a hierarchical product parameter associated with each of the plurality of actionable items, wherein the hierarchical product parameter is an operational factor associated with the product within a hierarchy of operational factors;
determine an entity from amongst the one or more entities operating in the distinct ecosystems in relation to the identified hierarchical product parameter, wherein the determined entity is authorized to undertake an action in relation to the identified hierarchical product parameter; and
transmit an indication of each set of the identified hierarchical product parameter and the associated actionable items therefor to the determined entity.

2. The system of claim 1, wherein the plurality of distinct ecosystems comprises at least one of a developer-end ecosystem and a user-end ecosystem.

3. The system of claim 1, wherein the hierarchy of operational factors is formed of:
a capability as a sub-unit of the product, wherein the capability represents functions performed by the product;
a feature as a sub-unit of the capability, wherein the feature represents an item configurable to perform a capability; and
a microservice as a sub-unit of the feature, wherein the microservice represents backend constructs for configuring the item performing the capability, wherein the hierarchical product parameter comprises at least one of the capability, the feature, and the microservice.

4. The system of claim 1, wherein to identify the plurality of actionable items, the processor is to:
cluster the events into one or more event clusters, wherein each event in the one or more event clusters is associated with an event entity and an event object, wherein the event entity is indicative of one or more entities operating in the distinct ecosystems associated with the event and the event object is indicative of a description of the event;
classify the one or more event clusters as incidents, wherein an incident is indicative of an event requiring a notification of the event objects to the event entity;
cluster the incidents into one or more incident clusters, wherein each incident in the one or more incident clusters is associated with an incident entity and an incident object, wherein the incident entity is indicative of one or more entities operating in the distinct ecosystems associated with the incident, and wherein the incident object is indicative of a description of the incident;
classify the one or more incident clusters as tickets, wherein a ticket is indicative of an incident requiring a cosmetic modification of the incident object by the incident entity;
cluster the tickets into one or more ticket clusters, wherein each ticket in the one or more ticket clusters is associated with a ticket entity and a ticket object, wherein the ticket entity is indicative of one or more entities operating in the distinct ecosystems associated with the ticket and wherein the ticket object is indicative of a description of the ticket; and
classify the one or more ticket clusters as issues, wherein an issue is indicative of a ticket requiring a structural modification of the ticket object by the ticket entity, wherein the plurality of actionable items comprises at least one of the incidents, the tickets, and the issues.

5. The system of claim 1, wherein the processor is to transmit the indication of the each set of the identified hierarchical product parameter and the associated actionable items therefor in response to a condition being fulfilled, wherein the condition is at least one of:
a rate of occurrence of event exceeding a threshold,
an identification of anomaly in one or more parameters associated with the actionable item; and
a level of severity of the associated actionable items exceeding a threshold level.

6. The system of claim 1, wherein the processor is to determine, within the hierarchy of operational factors comprising the identified hierarchical product parameter, another hierarchical product parameter affected by the action undertaken by the entity in relation to the identified hierarchical product parameter.

7. The system of claim 1, wherein the processor is further to determine a metric associated with the identified hierarchical product parameter, wherein the metric comprises at least one of usage metrics, revenue metrics, cost metrics, dependency metrics, and quality metrics.

8. The system of claim 7, wherein the processor is further to:
assign a priority ranking to the each set of the identified hierarchical product parameter and the associated actionable items, associated with the determined entity, based on the metric associated with the identified hierarchical product parameter; and
update the priority ranking upon identification of a subsequent actionable item.

9. The system of claim 7, wherein the processor is further to:
determine a relevance score for the identified hierarchical product parameter;
determine a metric score for the one or more metrics associated with the hierarchical product parameter;
identify a position of the identified hierarchical product parameter in the hierarchy of operational factors, based on a correlation of the relevance score and the metric score;
determine a hierarchical product parameters architecture based on the position of the identified hierarchical product parameter in the hierarchy of operational factors, wherein the hierarchical product parameters architecture represents an arrangement of links between identified hierarchical product parameters forming the hierarchy of operational factors; and
generate a view of the hierarchical product parameters architecture.

10. The system of claim 7, wherein the processor is further to:
predict, based on the one or more metrics, a probable actionable item that requires an action by the entity responsible for a hierarchical product parameter in relation to the probable actionable item.

11. A system to identify an operational factor for a product deployed in a plurality of distinct ecosystems comprising:
a data extraction engine to:
receive one or more programming files from one or more entities operating in a plurality of distinct ecosystems; and
extract one or more constructs and metadata associated with the one or more constructs from the one or more programming files; and
a discovery engine to:
correlate the one or more constructs and the metadata to obtain one or more operational factors responsible for each construct; and
identify, based on the correlation, one or more entities operating across the plurality of distinct ecosystems associated with each operational factor from amongst the one or more operational factors.

12. The system of claim 11, wherein the plurality of distinct ecosystems comprises at least one of a developer-end ecosystem and a user ecosystem.

13. The system of claim 11, wherein the data extraction engine is to extract the one or more constructs and metadata associated with the one or more constructs from the one or more programming files by parsing the programming files associated with the one or more entities operating at the plurality of distinct ecosystems.

14. The system of claim 11, wherein the data extraction engine is to extract data pertaining to engagement of one or more users with the operational factors and wherein the discovery engine is to:
determine, one or more users authorized to initiate an action on the identified entities associated with each operational factor.

15. The system of claim 11, wherein the discovery engine is to determine metrics associated with each operational factor, wherein the metrics comprise at least one of: usage metrics, revenue metrics, cost metrics, dependency metrics, and quality metrics.

16. The system of claim 12, wherein the one or more programming files include application programming interface (API) descriptor files received from the one or more entities operating in the user-end ecosystem.

17. The system of claim 16, wherein to identify the one or more entities operating in the user-end ecosystem associated with each operational factor, the discovery engine is to:
vectorize, using Natural Language Processing (NLP), each of the API descriptor files, wherein the vectorizing is to encode each operation in the API descriptor files, wherein similar operations result a similar encoding upon the vectorizing;
identify one or more features associated with the each encoded operation, wherein the one or more features is indicative of a portion of source code enabling operation of the operational factors;
augment each operation in the API descriptor files with the one or more features; and
determine, based on the one or more features augmented with each operation in the API descriptor files, one or more entities operating in the user-end ecosystem associated with each operational factor.

18. The system of claim 12, wherein the one or more programming files include at least one of: code files, deployment definition files, and deployment process files received from the one or more entities operating in the developer-end ecosystem.

19. The system of claim 18, wherein to identify the one or more entities operating in the developer-end ecosystem associated with each operational factor, the discovery engine is to:
create a knowledge graph comprising constructs extracted from the one or more programming files as nodes;
establish, based on syntactic knowledge, edges determining connections between the constructs;
enrich the knowledge graph to determine a missing edge between the constructs; and
determine the one or more entities operating in the developer-end ecosystem for each node in the knowledge graph.

20. A method for identifying an actionable event for a product deployed in a connected environment having a plurality of distinct ecosystems, the method comprising:
extracting, for the product, an event correlation map in relation to a plurality of events generated by the plurality of distinct ecosystems, wherein an event is indicative of an activity at one or more entities operating in the plurality of distinct ecosystems;
identifying a plurality of actionable items based on the event correlation map, wherein an actionable item is a response trigger associated with one or more events from amongst the plurality of events;
deducing correlations among the plurality of actionable items;
identifying, based on the correlations, a hierarchical product parameter associated with each of the plurality of actionable items, wherein the hierarchical product parameter is an operational factor associated with the product within a hierarchy of operational factors;
determining an entity from amongst the one or more entities operating in the distinct ecosystems in relation to the identified hierarchical product parameter, wherein the determined entity is authorized to undertake an action in relation to the identified hierarchical product parameter; and
transmitting an indication of each set of the identified hierarchical product parameter and the associated actionable items therefor to the determined entity.

21. The method of claim 20, wherein the plurality of distinct ecosystems comprises at least one of a developer-end ecosystem and a user-end ecosystem.

22. The method of claim 20, wherein the hierarchy of operational factors is formed of:
a capability as a sub-unit of the product, wherein the capability represents functions performed by the product;
a feature as a sub-unit of the capability, wherein the feature represents an item configurable to perform a capability; and
a microservice as a sub-unit of the feature, wherein a microservice represents backend constructs for configuring the item performing the capability, wherein the hierarchical product parameter comprises at least one of the capability, the feature, and the microservice.

23. The method of claim 20, wherein identifying the plurality of actionable items comprises:
clustering the events into one or more event clusters, wherein each event in the one or more event clusters is associated with an event entity and an event object, wherein the event entity is indicative of one or more entities operating in the distinct ecosystems associated with the event and the event object is indicative of a description of the event;
classifying the one or more event clusters as incidents, wherein an incident is indicative of an event requiring a notification of the event objects to the event entity,
clustering the incidents into one or more incident clusters, wherein each incident in the one or more incident clusters is associated with an incident entity and an incident object, wherein the incident entity is indicative of one or more entities operating in the distinct ecosystems associated with the incident, and wherein the incident object is indicative of a description of the incident;
classifying the one or more incident clusters as tickets, wherein a ticket is indicative of an incident requiring a cosmetic modification of the incident object by the incident entity;
clustering the tickets into one or more ticket clusters, wherein each ticket in the one or more ticket clusters is associated with a ticket entity and a ticket object, wherein the ticket entity is indicative of one or more entities operating in the distinct ecosystems associated with the ticket and wherein the ticket object is indicative of a description of the ticket; and
classifying the one or more ticket clusters as issues, wherein an issue is indicative of a ticket requiring a structural modification of the ticket object by the ticket entity, wherein the actionable item comprises at least one of the incidents, the tickets, and the issues.

24. The method of claim 20, comprising:
transmitting the indication of each set of the identified hierarchical product parameter and the associated actionable items therefor is in response to a condition being fulfilled, wherein the condition is at least one of:
a rate of occurrence of event exceeding a threshold,
an identification of anomaly in one or more parameters associated with the actionable item; and
a level of severity of the actionable item exceeding a threshold level.

25. The method of claim 20 further comprising:
determining, within the hierarchy of operational factors comprising the identified hierarchical product parameter, another hierarchical product parameter affected by the action undertaken by the entity in relation to the identified hierarchical product parameter.

26. The method of claim 20 further comprising:
determine a metric associated with the identified hierarchical product parameter, wherein the metric comprises at least one of usage metrics, revenue metrics, cost metrics, dependency metrics, and quality metrics.

27. The method of claim 26, further comprising:
a priority ranking to the set of the identified hierarchical product parameter and the associated actionable items, associated with the determined entity, based on the metric associated with the identified hierarchical product parameter; and
update the priority ranking upon identification of a subsequent actionable item.

28. The method of claim 26, further comprising:
determining a relevance score for the identified hierarchical product parameter;
determining a metric score for the one or more metrics associated with the hierarchical product parameter;
identifying a position of the identified hierarchical product parameter in the hierarchy of operational factors, based on a correlation of the relevance score and the metric score;
determining a hierarchical product parameters architecture based on the position of the identified hierarchical product parameter in the hierarchy of operational factors, wherein the hierarchical product parameters architecture represents an arrangement of links between identified hierarchical product parameters forming the hierarchy of operational factors; and
generating a view of the hierarchical product parameters architecture.

29. The method of claim 26, further comprising:
predicting, based on the one or more metrics, a probable actionable item that requires an action by the entity responsible for a hierarchical product parameter in relation to the probable actionable item.

30. A method for identifying an operational factor for a product deployed in a plurality of distinct ecosystems comprising:
receiving one or more programming files from one or more entities operating in a plurality of distinct ecosystems; and
extracting one or more constructs and metadata associated with the one or more constructs from the one or more programming files; and
correlating the one or more constructs and the metadata to obtain one or more operational factors responsible for each construct; and
identifying, based on the correlation, one or more entities operating across the plurality of distinct ecosystems associated with each operational factor from amongst the one or more operational factors.

31. The method of claim 30, wherein the plurality of distinct ecosystems comprises at least one of a developer-end ecosystem and a user-end ecosystem.

32. The method of claim 30, wherein the extracting one or more constructs and metadata associated with the one or more constructs from the one or more programming files comprises:
parsing the programming files associated with the one or more entities operating at the plurality of distinct ecosystems.

33. The method of claim 30, comprising:
extracting data pertaining to engagement of the one or more entities operating in the plurality of distinct ecosystems associated with each operational factor in order to determine to initiate an action on the identified entities associated with each operational factor.

34. The method of claim 30, comprising:
determining metrics associated with each of the one or more operational factors, wherein the metrics comprise at least one of: usage metrics, revenue metrics, cost metrics, dependency metrics, and quality metrics.

35. The method of claim 31, wherein the one or more programming files include Application Programming Interface (API) descriptor files received from the one or more entities operating in the user-end ecosystem.

36. The method of claim 35, wherein identifying the one or more entities operating in the user-end ecosystem associated with each operational factor, comprises:
vectorizing, using Natural Language Processing (NLP), each API descriptor files, wherein the vectorizing is to encode each operation in the API descriptor files, wherein similar operations result a similar encoding upon the vectorizing;
identifying one or more features associated with the each encoded operation, wherein the one or more features is indicative of a portion of source code enabling operation of the operational factors;
augmenting each operation in the API descriptor files with the one or more features; and
determining, based on the one or more features augmented with each operation in the API descriptor files, one or more entities operating in the user ecosystem associated with each operational factor.

37. The method of claim 31, wherein the one or more programming files include at least one of code files, deployment definition files, and deployment process files received from the one or more entities operating in the developer-end ecosystem.

38. The method of claim 37, wherein identifying the one or more entities operating in the developer-end ecosystem associated with each operational factor, comprises:
creating a knowledge graph comprising constructs extracted from the one or more programming files as nodes;
establishing, based on syntactic knowledge, edges determining connections between the constructs;
enriching the knowledge graph to determine a missing edge between the constructs; and
determining the one or more entities operating in the developer-end ecosystem for each node in the knowledge graph.
